(19) United States
(12) Patent Application Publication
(10) Pub. No.: US 2026/0225870 A1
(43) Pub. Date: Aug. 6, 2026

(54) A SYSTEM AND METHOD FOR PROCESSING AMPOULES

(71) Applicant: INTERVET INC., Rahway, NJ (US)

(72) Inventors: Michael Stephen SWERN, Boonton Township, NJ (US); Henrique Augusto CASAGRANDE, Watchung, NJ (US); Taylor Marcelo CORREA BARBOSA, Budd Lake, NJ (US); Michael Alexander COLLINS, Franklin, MA (US)

(73) Assignee: INTERVET INC., Rahway, NJ (US)

(21) Appl. No.: 19/149,706

(22) PCT Filed: Jan. 26, 2024
(86) PCT No.: PCT/EP2024/051895

§ 371 Date: Jul. 21, 2025

Related U.S. Application Data
(60) Provisional application No. 63/441,636, filed on Jan. 27, 2023.

(51) Int. Cl. B67B 7/92; A61J 1/20

(52) U.S. Cl. CPC B67B 7/92; A61J 1/20; A61J 2200/72

(57) ABSTRACT

A system for opening ampoules, the system comprising a beam comprising at least one opening for receiving part of an ampoule and an ampoule carrier for holding one or more ampoules. The system is configured to rotate the beam relative to the carrier, such that the rotation causes opposite sides of said opening to apply pressure to said received ampoule held by the carrier, to thereby break off said part of the ampoule received by the opening.

### TECHNICAL FIELD

The present disclosure relates to ampoule manufacturing, and in particular to systems and methods for automating the opening of ampoules and extraction of contents therein.

### BACKGROUND

The present disclosure generally provides systems, devices and methods for processing ampoules, for example ampoules containing a vaccine or other liquid.

In particular, the present disclosure generally relates to processes for the extraction of liquids from ampoules and the insertion of the liquids into diluent bags for use, as well as the opening of ampoules, the calibration of syringes and the detection of pre-thawed ampoules.

Ampoules are small sealed vials which are used to contain and preserve a (usually solid or liquid) sample or substance. Modern ampoules are commonly used to contain pharmaceuticals and/or other chemicals that must be protected from air and contaminants prior to use. As such, ampoules are often hermetically sealed e.g. by melting the top of the ampoule with an open flame after inserting the sample, and are typically opened by snapping off the head of the ampoule at the neck.

FIG. 1 shows an example of an ampoule 100. The ampoule 100 includes a head portion 102 and a body portion 106 connected by a neck portion 104. The neck 102 generally has a diameter that is smaller than the diameter of the head 102 or body 106. The head 102 forms a hermetic seal at the top of the ampoule allowing a substance such as a liquid 108 to be stored safely inside the ampoule 100. A base 106a of the body 106 may generally be referred to as the bottom of the ampoule 100, while the opposing upper side 102a of the head 102 may similarly be referred to as the top of the ampoule 100. However, it will be appreciated that references to a “top” and/or “bottom” of the ampoule are provided for clarity in the present disclosure with reference to the orientation of the ampoule shown in FIG. 1, and are not intended to be limiting in nature. For example, in some cases ampoules may be stored upside down (i.e. with the body 106 positioned above the head 102).

One pharmaceutical that may be stored in an ampoule such as ampoule 100 is a disease vaccine, for example an animal disease vaccine. Disease vaccines are traditionally hand prepared in a process that includes removing frozen ampoules from a liquid nitrogen store, thawing the ampoules in a water bath, cracking the heads off of the ampoules, carefully removing the vaccine from ampoules and injecting the vaccine into diluent bags. The diluent bags are marked with appropriate traceability information, and brought to different vaccination machines which can be used to vaccinate animals such as recently born (e.g. day old) chicks and/or animals in ovo.

However, aspects of this process are prone to errors, some of which may affect the successful preparation of a vaccine. For example, checks for determining that the ampoules have not thawed prior to their insertion into the water bath, as well as that they have been fully thawed by the water bath, are both typically done “by eye”, and as a result are reliant on the experience and/or skill of the responsible technician.

Errors in the preparation of the vaccines can carry a high cost in many industries. For example, field vaccination failures are extremely difficult to detect, and yet a single field vaccination failure (e.g. when vaccinating chicks) can be highly damaging to the health of the chicks. Such field vaccination failures are estimated to occur at a rate of at least one per year, even in larger hatcheries.

The applicant has therefore recognised the need to reduce the scope for errors in the vaccine preparation process, for example by automating parts or the entirety of the process.

While some of the benefits of automating the vaccine preparation process or parts thereof are apparent from the above disclosure, the need to consistently replicate the precise hand movements carried out by skilled technicians for the multiple steps of this process in a reliable manner has proven to be a significant barrier to such automation. In addition, ampoules may be provided in multiple sizes, each varying by a small amount. For example, many animal vaccines may be provided in either a small or tall ampoule, with an approximately 3 mm difference in size. While this discrepancy is largely unnoticeable for technicians preparing vaccines by hand, the need to account for such differences in the ampoules themselves further complicates any attempt to automate these processes.

It is therefore an aim of the present disclosure to provide a means and method to prepare vaccines in a fast, efficient manner while reducing the risk of field vaccination failures.

### SUMMARY OF INVENTION

In general, aspects of the present disclosure may provide a means and method for automating steps and processes for opening ampoules and/or removing liquids from the opened ampoules.

According to one aspect of the present disclosure, there is provided a system for opening ampoules, the system comprising
a beam comprising at least one opening for receiving part of an ampoule; and
an ampoule carrier for holding one or more ampoules,
wherein the system is configured to rotate the beam relative to the ampoule carrier, the rotation to cause opposite the beam to apply pressure to a said received ampoule held by the ampoule carrier, to thereby break off a said part of the ampoule received by the opening.

In order to utilise a sample stored within an ampoule, it is necessary to open the ampoules to provide access to the sample contained therein. This is usually accomplished by breaking off the head of the ampoule by hand (i.e. by snapping or cracking the neck portion of the ampoule to separate the head of the ampoule from the body of the ampoule). The necks of ampoules are generally marked or scored prior to this process, for example during the manufacturing process, to help to ensure a clean break. Ampoules are traditionally opened by hand one by one, in a time consuming process. As such, this step may often act as a bottle neck in e.g. the preparation of vaccines or other pharmaceuticals, or the ability to otherwise utilise a sample contained within the ampoule. Advantageously, the ampoule opening system of the present disclosure provides a means to automate the opening of multiple ampoules simultaneously, greatly improving the efficiency of, and reducing the time required for, this process.

The beam, also called a neck snapper or a neck cracker, may be connected to a motor at a first end, the motor configured to apply a torque force to the beam and cause the beam to rotate. Optionally, the beam may be rotationally mounted to a support structure at a second end that is opposite to the first end, to further improve the stability of the beam during rotation. Alternatively, the beam may be connected to motors at both the first and second end. In this implementation, both motors may be configured to provide a rotational force in the same direction (e.g. to reduce any flexing of the beam during use by providing matching torque forces from both ends of the beam). Alternatively, the motors may be configured to rotate the beam in opposite directions, to thereby provide a reverse rotation for e.g. returning the beam to a starting position after use. The motor(s) may be any suitable motor, such as a stepper motor.

The beam may be an elongated beam to provide space for multiple openings or holes in a single row or line. In this case, the first and second ends (i.e. the ends of the beam which are connected to the motors or motor and support structure) may be the opposing ends of the beam with the greatest separation between them.

The openings or holes of the beam may be uniformly spaced along the beam, to aid in the process of aligning the ampoules in an ampoule carrier or holder with the holes in the beam. The beam may have any number of holes, for example, 1, 2, 3, 4, 6, 8, etc. holes. In implementations, the number of holes in the beam is equal to a maximum ampoule carrying capacity of the ampoule carrier.

The beam may comprise a one or more flanges projecting from a surface of the beam. The one or more flanges are configured to contact the ampoules and thereby distribute the torque force from the beam to the ampoules. For example, the beam may comprise a first flange configured to contact the head of the one or more ampoules and a second flange configured to contact the neck of the one or more ampoules. The first flange may project from the beam approximately perpendicularly to the surface of the beam, while the second flange may project at an angle to the surface of the beam, such that it contacts the neck of the ampoule without contacting the head of the ampoule. Alternatively, both flanges may project from the beam at a non-perpendicular angle. Each flange may be between about 4 mm and about 12 mm in length, and the project at an angle from the beam of between about 70 degrees and about 110 degrees.

Advantageously, by imparting the torque force from the beam directly to the head and neck of the ampoule, the beam may achieve a cleaner and more consistent breaking of the ampoule neck. This is turn reduces the torque force required by the beam to break the neck of the ampoule (relative to a beam without any such flanges). Additionally, by suitably angling the second flange as described above, the beam may simultaneously open ampoules of differing sizes, such as small and tall ampoules, as the same separation between the ampoule carrier and the beam may be used in the opening process for both ampoule sizes.

The ampoule carrier and/or beam may be configured to move relative to one another, to insert the heads of the ampoule(s) held by the ampoule carrier into respective openings of the beam. For example, in one implementation, the beam remains stationary while the ampoule carrier travels or is otherwise moved upwards to insert the heads of the ampoule(s) into the holes of the beam from below. Alternatively, the beam may be hinged or otherwise detachable from its support structure, such that it can be positioned over the ampoule carrier to thereby receive the ampoules held by the ampoule carrier in its openings.

In implementations, the ampoule carrier and beam are configured to align one or more said ampoules held by the carrier with respective openings of the beam. As such, the ampoule carrier and/or the beam may be movable with respect to one another in one or more dimensions to facilitate this alignment. For example, the ampoule carrier and/or beam may be supported by one or more rails, and movable along these rails to align the ampoules with the respective holes. This movement may be manual (e.g. with a user sliding the ampoule carrier and/or beam along the rail(s)) or may be provided by one or more motors or other automated movement means. In one implementation, the beam is fixed in place while the ampoule carrier is movable along at least two perpendicular rails to thereby facilitate the movement of the ampoule carrier in two dimensions. The movement of the ampoule carrier in multiple dimensions facilitates both alignment of the ampoules held by the ampoule carrier with respective openings of the beam, and the insertion of the ampoules into the openings after said alignment.

After receiving the ampoules into the holes, the beam may be rotated to break off the ampoule heads from the ampoule bodies, by e.g. snapping the neck(s) of the ampoule(s) held by the ampoule carrier. The beam may be configured to rotate slowly until it contacts the ampoules held by the ampoule carrier. The angle of the beam relative to its starting position at the point at which it contacts the ampoules held by the ampoule carrier may be referred to as the contact angle. The rotational speed of the beam prior to reaching the contact angle may be sufficiently slow such that the impact between the beam and the ampoule(s) applies a static load to the ampoules. Optionally, after reaching the contact angle, the rotational speed of or the torque force applied to the beam may be increased, to thereby provide a sudden impulse or dynamic load to the ampoules and assist in snapping or breaking the neck(s) of the ampoule(s) in the ampoule carrier. The beam may rotate at a rotational speed of between about 1.5 RPM and about 2.5 RPM. In some implementations, the rotational speed may remain in this range both before and after reaching the contact angle. For example, the rotational speed may increase from 1.5 RPM (pre-contact) to 2.5 RPM (post contact).

The system may be configured to provide any suitable contact angle between the beam and the ampoules. In one implementation, the beam is configured with a contact angle between 40 and 50 degrees from the horizontal, between 45 and 50 degrees from the horizontal, or about 47 degrees from the horizontal. The contact angle may be adjusted by various means, such as by adjusting the relative heights of the ampoule carrier and the beam, and/or by altering a length or angle of the beam flanges.

In implementations, the system may comprise a bottom plate configured to support the ampoule carrier during the rotation of the beam. The bottom plate may attach to the ampoule carrier after the insertion of the ampoules into the holes in order to reinforce the ampoule carrier against the torque forces imparted by the rotation of the beam.

In implementations, the system further comprises a collection area for depositing ampoule heads after they have been separated from the ampoule bodies. Some or all ampoule heads may be ejected away from the ampoule bodies due to the forces of the neck snapping process. However, to deposit any ampoule heads remaining in the beam openings, the beam may be configured to continue rotating after snapping the necks. For example, after breaking the necks of the one or more ampoules, the system may be configured to lower the ampoule carrier and continue rotating the beam until the beam returns to its starting position (i.e. corresponding to a 360-degree rotation of the beam). The continued rotation of the beam may result in any removed ampoule heads falling from the beam openings and into a collection area. Advantageously, this process also returns the beam to its starting position in preparation for further use, without the provision of an additional reverse motor (or reverse gearing) and/or the use of a reversible motor.

According to a further aspect of the present disclosure, there is provided a method of opening one or more ampoules, the method comprising:
depositing one or more ampoules into an ampoule carrier;
receiving the one or more ampoules into respective openings of a beam; and
rotating the beam to relative to the ampoule carrier, the rotation to cause the beam to apply pressure to the one or more ampoules and thereby break off a said part of the ampoule received by the opening.

According to another aspect of the present disclosure, there is provided a method of detecting a thawed ampoule, the method comprising:
detecting, by a photosensor, an average colour of an ampoule;
comparing the detected colour of the ampoule to a predetermined colour; and
determining, based on the comparison, whether the ampoule and/or a substance contained within the ampoule has thawed.

It will be appreciated that any reference herein to a ‘thawed’ ampoule is a reference to an ampoule having thawed or softened contents. Similarly, any reference to a ‘frozen’ ampoule is a reference to an ampoule having frozen or solidified contents.

The method may further comprise, if an ampoule is determined to have thawed, providing a notification or other warning to a user. For example, the method may comprise halting or delaying some or any subsequent processes.

Some substances commonly contained or stored in ampoules, such as several animal vaccines, are preferable frozen until they are required for use, in order to improve the durability of the vaccines. A failure of the storage device may therefore lead to premature thawing of the vaccines (or any other substances) contained within the ampoules. If the failure is temporary, the contents of the ampoule may later re-freeze. This re-freezing often results in it being difficult to determine whether any premature thawing has occurred, and therefore whether the ampoules contents are safe for use. Alternatively, the failure of the storage device may be permanent, or the ampoules may otherwise be removed from storage early, causing the substances contained therein to thaw before they are required. These prematurely thawed substances can result in significant issues in later use. For example, a prematurely thawed vaccine may lose its effectiveness by the time it is provided to a patient or an animal, potential resulting in large scale field vaccination failures. Thus, by automatically detecting that the contents of one or more ampoules has thawed, the risk of such large scale vaccination failures may be reduced.

The frost that gathers on a frozen ampoule results in the frozen ampoule reflecting a different colour of light to a thawed ampoule. As a result, by comparing the average colour of an ampoule to a predetermined colour or range of colours for a frozen ampoule containing that substance, it is possible to determine whether an ampoule has thawed. Thus, in implementations the photosensor is configured to detect an average colour of the ampoule, and compare this average colour to a predetermined (acceptable) colour or range of colours that correspond to a frozen ampoule.

In implementations therefore, the step of comparing the detected colour of the ampoule to a predetermined colour comprises comparing the detected colour to a predetermined colour or selection of predetermined colours. The predetermined colour(s) may be stored in e.g. a look up table, or any other suitable database. Additionally or alternatively, the step of comparing the detected colour of the ampoule to a predetermined colour may comprise determining a photon wavelength that corresponds to the detected colour, and comparing the determined photon wavelength to a predetermined photon wavelength or range of photon wavelengths. Any other method for comparing a detected colour of an ampoule to a (predetermined) desired colour or range of colours may also be used.

The (pre-determined) correlation between the status of the vaccine and the detected average colour of the ampoule may be stored in e.g. a look up table or database, and used by a processor of the photodetector to determine whether not the vaccine has thawed based on the detected colour. This process may occur via e.g. a logic operator circuit that may return one value (e.g. true) is the vaccine or other substance is frozen, and a second value (e.g. false) if the vaccine or other substance is thawed. The logic operator circuit may be implemented on any suitable hardware or software, such as via a dedicated logic comparison circuit or via a program executable by the processor.

As previously discussed, ampoules may be stored upside down (i.e. with the ampoule head below the ampoule body). As a result, a storage failure leading to a thawing of an ampoule may result in the substance contained within the ampoule flowing into the head of the ampoule from the ampoule body. If this substance is later refrozen, it will typically remain in the ampoule head while in its frozen state, even if the orientation ampoule is later changed (due to e.g. the constricted neck portion of the ampoule). Therefore, in one implementation, the photosensor may be configured to detect whether any of the substance contained in the ampoule is present in the head of the ampoule, to thereby determine that the ampoule and/or the substance contained therein has previously thawed and been refrozen.

The method for detecting a thawed ampoule may comprise providing a background with a fixed colour on an opposite side of the ampoule to the photosensor. By providing a background with a fixed colour, the accuracy of the measurements by the photosensor may be increased. This is because the colour of light reflected by the frost gathered on a frozen ampoule may vary depending on the colour of the ampoule's surroundings. Therefore, providing a consistent background colour may increase the accuracy of the method in detecting thawed ampoules, or otherwise reduce the number of potential ‘frozen’ ampoule colours to be stored in the look-up table or database. In implementations, the background may be provided with an average colour corresponding to photons with a wavelength of between 450-485 nanometres, or an average colour corresponding to photons with a wavelength of between 450-465 nanometres. For some animal vaccines, it has been found that background colours corresponding to these wavelengths (i.e. blue or royal blue backgrounds) provide a particularly suitable colour contrast for the detection of thawed ampoules. However, the most suitable background colour may depend on the substance contained within the ampoule, as well as the construction of the ampoule itself (and therefore the average colour of the ampoule as a whole).

If the ampoules are provided in an ampoule carrier, the photosensor may be used to determine a position of the ampoule or ampoules in the ampoule carrier, such that any later processes can use this information to locate the ampoules. Thus, in some implementations, the method may further comprise detecting, by the photosensor, a position of the ampoule.

It will be appreciated that the processing steps required to determine the state of the ampoules and/or the presence/absence of an ampoule may be performed by a processor or other computer device. The processor may be provided as part of the photosensor, or may be an external processor configured to receive data from the photosensor. In implementations, the photosensor may comprise a processor configured to perform initial processing steps on the raw data detected by the photosensor, and provide the processed data to an external processor or computer device for further analysis.

According to a further aspect of the present disclosure, there is provided a system for determining a substance contained within an ampoule has thawed, the system comprising:
a photosensor configured to detect an average colour of the ampoule; and
a processor configured to:
   compare the detected colour of the ampoule to a predetermined colour; and
determine, based on the comparison, whether the ampoule is thawed
wherein the system is configured to halt or delay a process for progressing the opening of or processing the contents of at least the one or more ampoules that are determined to have thawed.

According to another aspect of the present disclosure, there is provided a method of calibrating a syringe assembly for removing a liquid from one or more ampoules, the method comprising:
exerting a force on a load cell with a syringe of the syringe assembly;
determining when the syringe assembly is exerting the force on the load cell based on an output of the load cell; and
determining a height of the syringe based on a position of the syringe assembly when the syringe contacts exerts the force on the load cell.

When extracting a liquid from an ampoule by hand, the tip of a syringe needle should ideally be positioned close to but not contacting a base of the ampoule, to allow the syringe to remove all of the liquid and minimise waste (i.e. leftover or non-removed liquid). While this process is relatively simple for a skilled technician to accomplish by hand, attempts to automate the extraction process are complicated by variability in the lengths of syringe needles. Needles that are shorter than expected may fail to remove all of the liquid, while needles that are longer than expected may contact the base of the ampoule, potentially resulting in damage to the ampoule and/or the syringe itself.

The present disclosure therefore provides a means and method for determining a position of the tip of a syringe needle.

In implementations, the method may further comprise providing a body of a known size on the load cell, and the step of exerting a force on a load cell with a syringe of the syringe assembly comprises bringing the syringe into contact with the body. For example, the body may be a diluent bag. Advantageously, diluent bags generally provide a sanitary surface, and may therefore reduce the required maintenance of the machine (e.g. cleaning between uses) while reducing the risk of compromising the cleanliness of the needle.

The point of contact between the syringe and the load cell or body may be determined from a change (e.g. an increase) in the output measurement of the load cell due to the contact between the syringe and the body. By providing a body on the load cell with a known height, the contact height of the syringe (and therefore the length of the syringe needle relative to the syringe assembly) may be determined.

The body placed or positioned on the load cell may be any object of a known size, or an object with a size that may be determined based on load cell measurements. For example, if a body may be provided in multiple discrete sizes, the size of the body may be determined based on an initial (weight) measurement or reading from the load cell. One example of such a body are diluent bags. As diluent bags may be provided in one or more standardised sizes that are each configured to hold a specified amount of fluid, each size of diluent bag has a corresponding weight that falls within a small range of acceptable values. Thus, the size of the diluent bag may be determined by measuring its weight.

In implementations therefore, the body is a diluent bag and providing the body comprises:
depositing the diluent bag on the load cell; and
determining a size of the diluent bad based on an initial output of the load cell.

In further implementations, determining the height of the syringe comprises determining an offset value from an expected syringe height. Syringes may be provided in one or more standardised sizes. The method may therefore comprise detecting the offset of the syringe from the expected or theoretical height of the syringe. This offset value may then be stored and/or used to determine a suitable adjustment for the height of the syringe assembly in later processes (e.g. when extracting a fluid (such as a vaccine) from an ampoule).

According to another aspect of the present disclosure, there is provided a method of removing a liquid from one or more ampoules, the method comprising:
calibrating a syringe assembly comprising one or more syringes according to the above aspect;
aligning the syringe assembly with an ampoule;
inserting the syringe into an ampoule using the determined height of the syringe such that a tip of the syringe is adjacent to but not contacting a base of the ampoule; and
removing the liquid from the ampoule using the syringe.

By removing liquid from the syringe using the determined syringe height or offset, the method facilitates the optimal placement of the syringe in the ampoule. As described above, this in turn increases or maximises the liquid extracted from the ampoule while reducing the risk of accidental contact between the syringe and the ampoule.

In implementations, the ampoule is placed in a known or fixed position. Placing the ampoule in the known position may comprise rotating the ampoule such that an axis of the ampoule is rotationally offset from an axis of the syringe by up to 10 degrees, for example by about 5 degrees. The rotational offset between the ampoule and the needle directions may help to increase the amount of liquid removed or removable from the ampoule by the syringe.

The method may further comprise, prior to inserting the syringe into a first ampoule of the one or more ampoules, drawing air into the syringe. Drawing air into the syringe results in the formation of an air bubble, thereby increasing the amount of liquid in the syringe which may later be ejected from the syringe e.g. in an injection process. Without providing this air pocket, a small amount of liquid may remain in the syringe even after the plunger has been fully inserted into the barrel.

In implementations, the method comprises detect a position of the one or more ampoules. For example, the ampoule position may be detected by a photosensor. Optionally, this detection may occur during e.g. a thaw detection process, as previously described. Detecting a position of the ampoules facilitates the alignment of the syringe assembly with the one or more ampoules. However, alternative methods may be used to facilitate this alignment, such placing the ampoules in a known or fixed location.

In implementations of the method, when the one or more ampoules comprises a plurality of ampoules:
aligning the syringe assembly with an ampoule comprises aligning the syringe assembly with a first ampoule of the plurality of ampoules;
inserting the syringe into the ampoule comprises inserting the syringe into the first ampoule using the determined height of the syringe such that a tip of the syringe is adjacent to but not touching a base of the first ampoule; and
removing the liquid from the ampoule comprises removing the liquid from the first ampoule using the syringe;
and the method further comprises, after removing the liquid from the first ampoule:
aligning the syringe assembly with a second ampoule of the plurality of ampoules;
inserting the syringe into the second ampoule using the determined height of the syringe such that a tip of the syringe is adjacent to but not touching a base of the second ampoule; and
removing the liquid from the second ampoule using the syringe.

By extracting liquid from each ampoule in turn, a single syringe may be used to extract liquid from some or all of the plurality of ampoules, without the need to empty or change the syringe between each liquid extraction process.

According to a further aspect of the present disclosure, there is provided a system for calibrating a syringe assembly for removing a liquid from one or more ampoules, the system comprising:
a load cell;
a syringe assembly comprising one or more syringes, wherein the syringe assembly is movable relative to the load cell; and
a processor configured to:
   detect when the syringe assembly is in contact with the load cell or a body disposed on the load cell based on an output of the load cell; and
   determine a height of the one or more syringes based on a position of the syringe assembly when the syringe assembly is in contact with the load cell or the body.

In implementations, the system comprises an ampoule carrier for holding one or more ampoules, and the syringe assembly is further configured to remove a liquid from the one or more ampoules based on the determined height of the one or more syringes.

It will be understood that the systems described above may each be provided separately. Alternatively, some or all of these systems may be combined into a single system, to thereby provide a system for automating any, some or all of the processes of opening ampoules, calibrating a syringe assembly, extracting the contents of the ampoules, detecting a position or number of the ampoules and/or detecting a thawed ampoule. Some or all of the above described methods may also be combined.

Thus, according to an aspect of the present disclosure, there is provided a system for extracting a liquid from an ampoule, the system comprising:
an ampoule carrier for holding one or more ampoules,
a photosensor configured to detect an average colour of each of the one or more ampoules;
a beam comprising at least one opening for receiving part of an ampoule, wherein the system is configured to rotate the beam relative to the ampoule carrier, the rotation to cause opposite the beam to apply pressure to a said received ampoule held by the ampoule carrier, to thereby break off a said part of the ampoule received by the opening;
a load cell;
a syringe assembly comprising one or more syringes, wherein the syringe assembly is movable relative to the load cell and configured to remove a liquid from the one or more ampoules; and
one or more processors configured to:
   compare the detected colour of the ampoule to a predetermined colour;
   determine, based on the comparison, whether the ampoule is thawed, wherein the system is configured to halt or delay a process for progressing the opening of or processing the contents of at least the one or more ampoules that are determined to have thawed;
   detect when the syringe assembly is in contact with the load cell or a body placed on the load cell, based on an output of the load cell; and
   determine a height of the one or more syringes based on a position of the syringe assembly when the syringe assembly is in contact with the load cell or the body;
      wherein the syringe assembly is configured to remove a liquid from the one or more ampoules based on the determined height of the one or more syringes.

It will be understood that the previous descriptions relating to the systems and method for opening ampoules, calibrating the syringe assembly, removing liquid from the one or more ampoules, detecting a position or number of the ampoules and detecting whether an ampule has thawed may be applied equally to the combined system.

The system may further comprise a water bath configured to receive one or more ampoules held by the ampoule carrier, and thaw at least one of the ampoules or the contents stored therein. In implementations, the system comprises an IR thermometer for detecting a temperature of one or more ampoules held by the ampoule carrier after the ampoules have been removed from the water bath, wherein the IR thermometer is configured to determine whether one or more ampoules held by the ampoule carrier have thawed.

The system may further be configured to, during the removal of the liquid from the one or more ampoules, rotate the ampoule carrier relative to the syringe assembly by up to 10 degrees, or by about 5 degrees. Alternatively, the ampoule carrier may be held at a fixed rotation relative to the syringe assembly by up to 10 degrees, or by about 5 degrees, as previously described.

The load cell or cells may be configured for holding one or more diluent bags, and the one or more syringes configured to insert the removed liquid into the one or more diluent bags placed on the load cell(s).

The system may further comprise rolling assemblies configured to mix the liquid in the diluent bags, by e.g. massaging the diluent bags after the injection process.

In implementations, the syringe assembly may comprise a second one or more syringes configured to inject a dye into the one or more diluent bags. Alternatively, a single syringe may be used to both inject a dye into the one or more diluent bags and extract a liquid from the one or more ampoules. In implementations, the syringe assembly may therefore be configured to inject a dye into the one or more diluent bags prior to extracting a liquid from the ampoules, for example during or after the syringe calibration process.

The ampoule carrier may be configured to, after the removal of the liquid, deposit the one or more ampoules in a collection area. In implementations, the ampoule carrier may comprise a hinged or otherwise movable/openable base to facilitate the removal of the (empty) ampoule bodies, and/or any thawed ampoules that are detected during a thaw detection process.

The systems described above may be contained within a housing structure to form a single device, and/or a controller may be provided to control the operations of the system.

According to a further aspect of the present disclosure, there is provided a method of extracting a liquid from an ampoule, the method comprising:
depositing one or more ampoules into an ampoule carrier;
detecting, by a photosensor, an average colour of an ampoule;
comparing the detected colour of the ampoule to a predetermined colour;
determining, based on the comparison, whether the ampoule is thawed;
receiving the one or more ampoules into respective openings of a beam;
rotating the beam to relative to the ampoule carrier, the rotation to cause the beam to apply pressure to the one or more ampoules and thereby break off a said part of the ampoule received by the opening
exerting a force on a load cell with a syringe of the syringe assembly;
determining when the syringe assembly is exerting the force on the load cell based on an output of the load cell; and
determining a height of the syringe based on a position of the syringe assembly when the syringe contacts exerts the force on the load cell;
aligning the syringe of the syringe assembly with an opened ampoule;
inserting the syringe into an ampoule using the determined height of the syringe such that a tip of the syringe is adjacent to but not touching a base of the ampoule; and
removing the liquid from the ampoule using the syringe.

It will be understood that the various implementations described above in relation to the method for calibrating the syringe assembly apply equally to the corresponding steps of this method.

According to a further aspect of the present disclosure, there is provided a use for any of the systems or methods described above for preparing one or more diluent bags comprising a vaccine.

### DESCRIPTION OF DRAWINGS

Some embodiments of the disclosure will now be described by way of example only and with reference to the accompanying drawings, in which:

FIG. 1 depicts a schematic diagram of an example ampoule.

FIGS. 2a, b and c depict an example device according to the present disclosure.

FIGS. 3a and b depict an example ampoule receiver according to the present disclosure.

FIGS. 4a, b and c depicts an example ampoule holder according to the present disclosure.

FIG. 5 depicts a schematic diagram of an example colour scanner or sensor according to the present disclosure.

FIGS. 6a, b and c depict an example water bath according to the present disclosure.

FIG. 7 depicts a schematic diagram of an example infrared (IR) thermometer or scanner according to the present disclosure.

FIGS. 8a-h depict examples of an ampoule opening assembly according to the present disclosure.

FIG. 9 depicts an example ampoule disposal system according to the present disclosure.

FIGS. 10a, b, c and d depict an example syringe assembly according to the present disclosure.

FIGS. 11a, b and c depicts an alternative example syringe assembly according to the present disclosure.

FIGS. 12a, b and c depict example diluent bag holders according to the present disclosure

FIG. 13 depicts an example roller assembly according to the present disclosure.

FIG. 14 shows an example method for extracting the contents of an ampoule.

### DEFINITIONS

The skilled person will understand that in the preceding and appended description and claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

Although the disclosure is described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in any embodiments, whether alone or in any appropriate combination with any other feature disclosed or illustrated herein.

### DESCRIPTION OF EMBODIMENTS

Aspects of the invention will now be described by reference to example embodiments. The embodiments described herein primarily relate to vaccination machines which can be used to prepare vaccines to vaccinate animals such as recently born (e.g. day old) chicks. However, it will be appreciated that the systems, method and devices disclosed herein are not limited in this way, and may be configured for use with any ampoules, pharmaceuticals and/or chemicals.

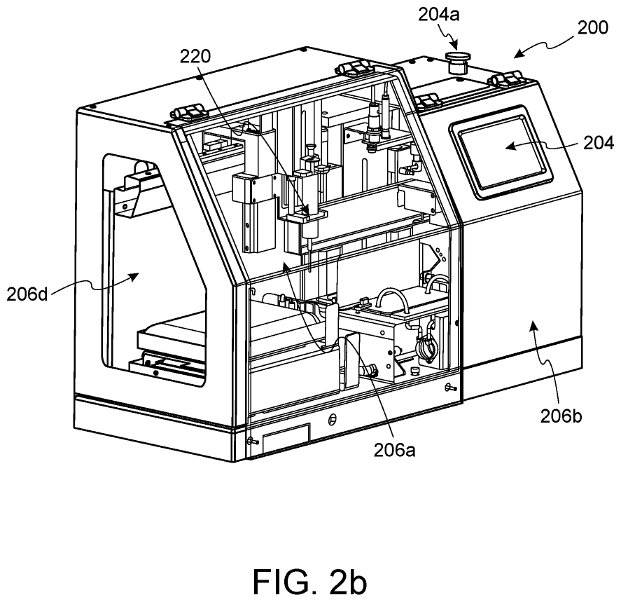

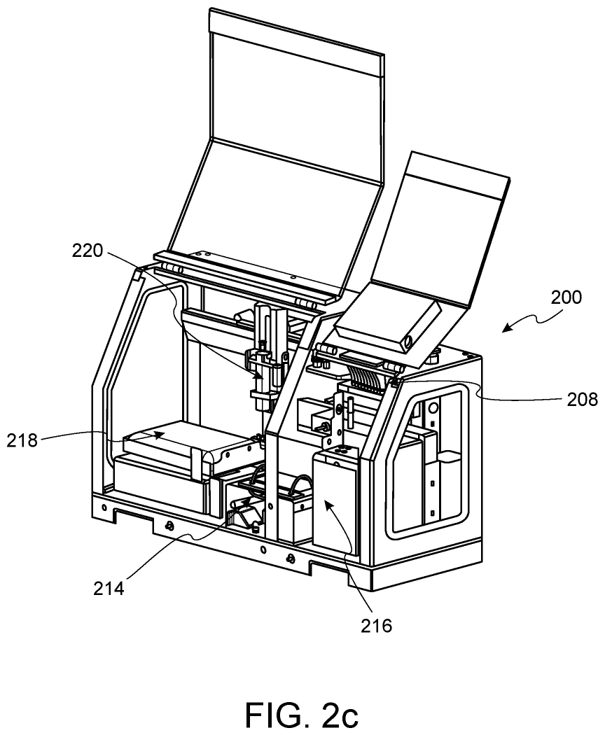

FIGS. 2a-c show various views of a vaccination machine 200 for preparing animal vaccines for use. It will be understood that while machine 200 is depicted as a single device contained within a housing 202, the various components described herein may instead be provided individually and/or as part of a system without being contained within a single housing unit.

The housing 202 comprises a display unit 204 for displaying information to the user, and an input means 204a for receiving inputs from the user. The input means 204a may be any suitable means for inputting information into the device, such as a keyboard and/or one or more dials. In some example implementations, the display means 204 and input means 204a may be combined into a single touch screen display. However, additional input means, such as a back-up keyboard or an emergency stop button, may also be provided.

Housing 202 is further provided with apertures 206a and b to allow access to the various internal components of the machine 200 for e.g. ease of cleaning and maintenance of the components. Each of the apertures 206a and b may comprise a movable barrier such as a door or hatch to seal the opening, for example during operation of the device.

Additional apertures, such as apertures 206c and d, may be included in the housing 202 to provide visibility of the components during operation of the machine 200, to e.g. allow the user to manually observe any ongoing processes, and/or to check for any errors or other issues. Apertures 206c and d may be sealed with a transparent material, such as glass or plastic for improved user safety without restricting visibility of the machine components.

Internally, the machine comprises several components for assisting in the preparation of the vaccines. These components may include but are not limited to an ampoule receiver 208, an ampoule holder, one or more rails or other movement means for the ampoule holder, a water bath system 214, an ampoule collection area or bin 216, one or more diluent bag holders or trays 218, a syringe assembly 220, a photosensor, an infrared (IR) thermometer or detector, a printer or printing device, and an ampoule opening assembly, also called an ampoule neck snapper or neck cracker. Each of these components will be discussed in further detail below. It will be understood that the internal components of the machine 200, such as the ampoule opening assembly, may be provided separately from the rest of the components of the machine 200 in order to automate specific parts of the manufacturing process. For example, the ampoule opening assembly may be provided in isolation to automate the opening of ampoules, with the remainder of the (e.g. vaccine preparation) process occurring by hand.

Housing 202 may further comprise a control unit, such as a computer or processor, for controlling the operations of the machine 200. Alternatively, the operations of machine 200 may be controlled by an external device, such as an external computer, processor, mobile device, etc.

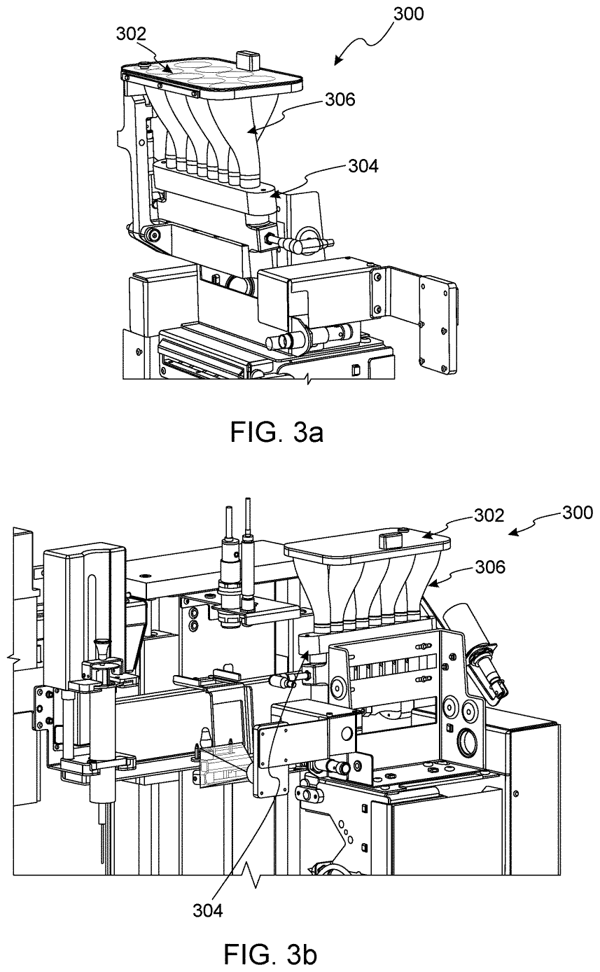

FIGS. 3a and b show an example ampoule receiver 300 for inserting one or more ampoules into the machine. The ampoule receiver 300 may comprise one or more first openings 302 for receiving an ampoule from a user, and one or more second openings 304 for depositing an ampoule into the ampoule holder. The first and second openings 302, 304 are connected on a one to one basis by chutes 306. In this example, first openings 302 are larger than second openings 306, resulting in a funnel shaped chute 304 between the openings. Advantageously, this results in an increased spacing between the first openings for ease of use by the user, particularly for any users attempting to operate the machine while wearing protective gear, such as gloves. The smaller second openings 304 provides greater control over the placement of the ampoules in the ampoule holder. It will be understood that the first and second openings 302 and 304 may instead be the same size, or first opening 302 may be smaller than second opening 304. Similarly, chutes 306 may be any shape suitable for directing and depositing the ampoules. For example, the chutes 306 may be cylindrical, or may each have a different shape.

The ampoule receiver 300 may comprise any number of chutes 306 up to a maximum capacity for the machine. For example, if the machine has a maximum capacity of eight ampoules, the ampoule receiver 300 may have eight first openings 302, second openings 304 and chutes 304, as depicted in FIG. 3. It will be understood that the ampoule receiver 300 may comprise fewer chutes than the maximum capacity of the machine. For example, the ampoule receiver 300 may comprise only a single chute, and the ampoule holder may change position after each ampoule is deposited, such that a subsequent ampoule will be deposited into an empty space or slot of the ampoule holder.

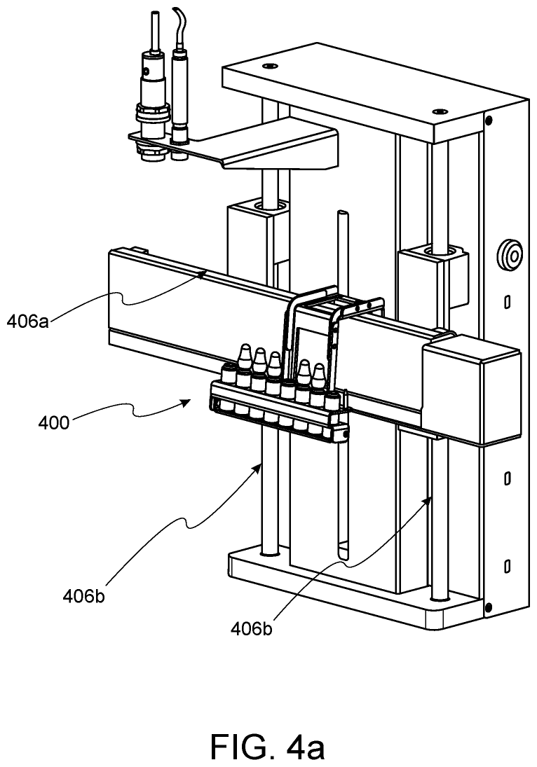

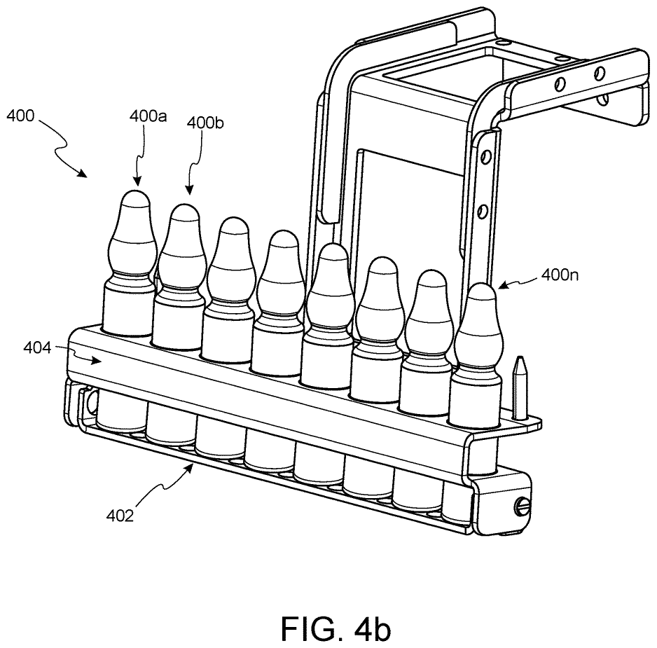

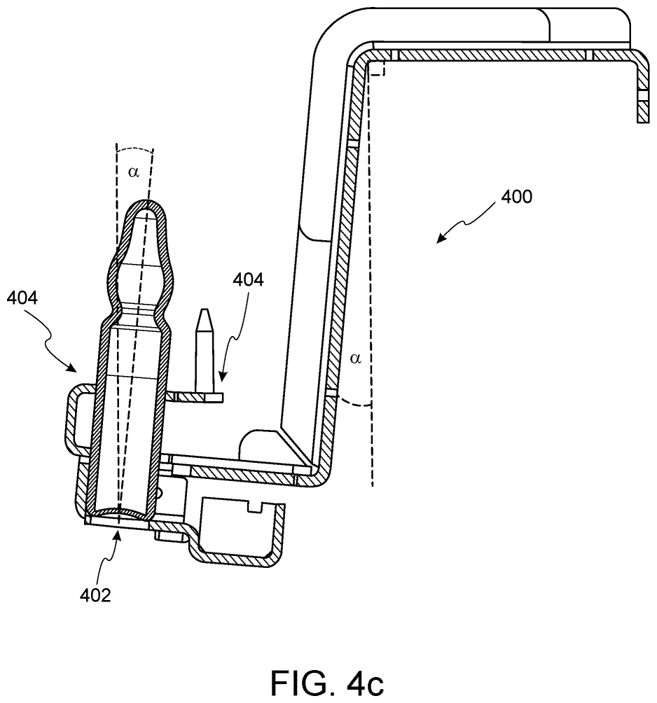

FIGS. 4a-c show an example ampoule holder or carrier 400. The ampoule holder 400 is shown with a maximum capacity of eight ampoules corresponding to the eight chutes of ampoule receiver 300, however it will be understood that ampoule holder 400 may more generally hold any number of ampoules. The ampoule holder 400 is configured to receive one or more ampoules 400a, b . . . n from the ampoule receiver and transport the ampoules through the machine. The ampoule receiver may comprise a base 402 for supporting the ampoules, and a support beam 404 for retaining the ampoules within the ampoule holder during the operation of the machine. The support beam 402 may comprise one or more holes for receiving the ampoules, with the number of holes determining a maximum capacity of the machine. The ampoule holder 400 may be configured to hold a single row of ampoules, as shown in FIGS. 4a and b, or may be configured to hold multiple rows of ampoules, e.g. to increase the capacity of the machine.

The base 402 of the ampoule holder may be hinged or may otherwise be openable, for example via a trap door mechanism, to facilitate the removal of the ampoules from the ampoule holder 400. This hinge or mechanism may be operated by any suitable means, such as a spring mechanism or a counterbalance system. The machine comprises rails 406a, b for transporting the ampoule holder 400, with vertical 406b and horizontal 406a rails facilitating the vertical and horizontal movement respectively of the ampoule holder 400. In the example shown in FIG. 4a, two vertical rails 406b are provided to further increased the stability of the ampoule holder 400. Control of the movement along the rails 406a, b may be provided by one or more motors, which may be positioned either in or on the ampoule holder 400 itself or on the rails. While rails 406a, b beneficially provide a large degree of stability to the ampoule holder 400, and therefore reduce the risk of an ampoule falling out of the holder or otherwise being damaged and/or spilling its contents, any suitable means may be used to provide and control the movement of the ampoule holder 400 throughout the machine.

The ampoule holder 400 may be rotatable such that, in use, the base 402 can be set at an angle to the vertical. For example, the ampoule holder may be rotatable between 0-10 degrees from the vertical, 0-5 degrees from the vertical, or any other suitable amount of rotation. Alternatively, the ampoule holder 400 may be rotationally fixed such that the ampoules are held at a set (fixed) angle α to the vertical, as shown in FIG. 4c. For example, the set/fixed angle may be 0 degrees, 5 degrees or 10 degrees, or any other suitable value. Maintaining the ampoule holder 400, and therefore the ampoules themselves, at a set angle has been found to improve the stability of the ampoules in the ampoule holder 400, as well as assisting in the extraction of the vaccines from the ampoules by increasing the amount of liquid that can be reliably extracted by a syringe.

After inserting the ampoules into the machine, a colour scanner system 500 may be used to detect (i) a position of the or any ampoules in the ampoule holder 508, (ii) whether the contents of any of the ampoules have thawed, and/or (iii) whether the contents of any of the ampoules have previously thawed and been refrozen.

The photosensor 502, also called a colour sensor or colour scanner, may be used to determine a colour of the ampoules, for example by detecting an average RGB pixel colour for each ampoule. As such, the system 500 or the photosensor 502 itself may comprise a processor for processing the raw data collected by the photosensor 502. Alternatively, raw or processed data from the photosensor 502 may be provided to an external computing device or processor, such as the machine controller, for further analysis.

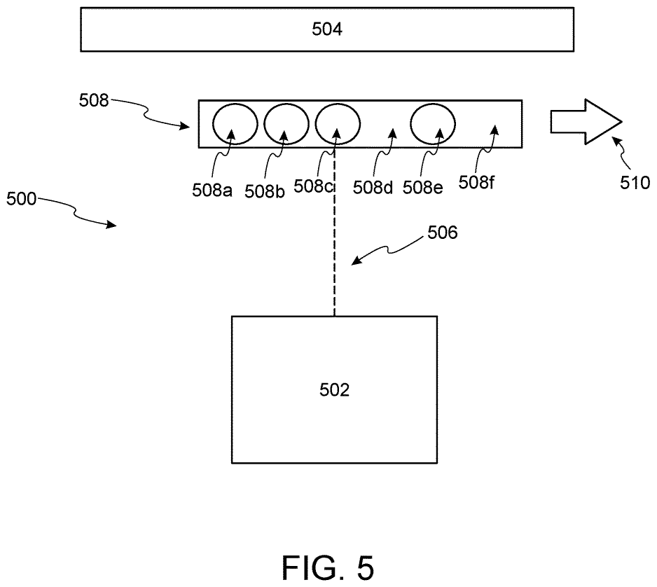

The processor may determine the number of ampoules inserted into the ampoule holder 508 and/or the position of the ampoules in the ampoule holder 508 based on the photons detected by the photosensor 502. In the example shown in FIG. 5, the ampoule holder 508 travels across the field of view of the photosensor 502, as shown by arrow 510. As the ampoule holder travels past the photosensor 502, the photosensor 502 can detect incoming photons 506 to scan each slot 508a-f of the ampoule holder 508 in turn. By comparing the colour or wavelength of the detected photons 502 to a predetermined or expected ampoule colour, the processor or other computer device can determine whether or not an ampoule is present in a given slot of the ampoule holder 508. For example, the system 500 may detect that ampoules are present in slots 508a, b, c and e, but not present in slots 508d and f.

This process may be generalised to ampoule carriers with any carrying capacity. In a further example, if only three ampoules have been inserted into an ampoule holder with a maximum ampoule capacity of eight, the photosensor may determine that ampoules are present in e.g. positions 1, 2 and 4 of the ampoule holder but absent from positions 3, 5, 6, 7 and 8.

The ampoule holder 508 may travel past the photosensor 502 at a constant speed, or may alternatively be repeatedly stopped to allow the photosensor 502 to scan each slot 508a-f for a longer period of time. Increasing the amount of time the photosensor 502 is able to spend scanning each slot 508a-f may improve the accuracy of the detected data and reduce the possibility of scanning errors. It will be further understood that photosensor 502 may be configured to scan some or all of the slots simultaneously.

Information on the number and/or position of the ampoules in the ampoule holder 508 may also or alternatively be provided to the system 500 by the user via e.g. a display or input means of the machine housing. In this case, the system 500 may validate the input data to reduce the potential for user error. For example, the system 500 may only detect the average RGB pixel colour in the slot positions indicated by the user. Additionally or alternatively, the system may confirm the absence of ampoules in the slots indicated as empty by the user input.

The photosensor can also or instead be used to detect whether the contents of an ampoule have thawed. This process may involve detecting the average (RGB) colour of the ampoule, and comparing this average colour to a predetermined acceptable colour or range of colours. A colour reflected by the frost present on a frozen ampoule results in the ampoule reflecting a different colour of light to a thawed ampoule. As a result, the correlation between the status of the ampoule contents (such as a vaccine) and the colour of the ampoule may be stored in e.g. a look up table or database, and used by a processor of the photodetector 502 (or other external processor/computing device) to determine whether not the ampoule's contents have thawed, for example based on a comparison between the detected colour or detected photon wavelength and a predetermined acceptable colour or range of colours. This comparison process may occur via any suitable means. For example, the system 500 may utilise a logic operator circuit that may return one value (e.g. true) is the vaccine is frozen, and a second value (e.g. false) if the vaccine is thawed. The logic operator circuit may be implemented on hardware via a dedicated logic comparison circuit or via software executable by the processor.

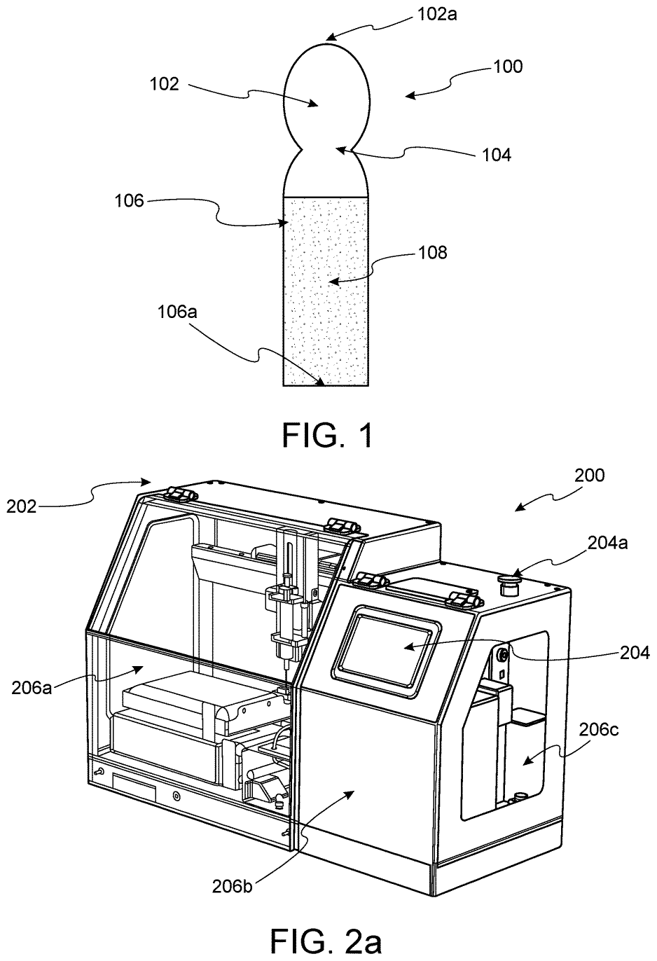

The photosensor 502 may also or instead be used to determine whether the contents of an ampoule have previously thawed and later been refrozen. This process may comprise determining whether the (frozen) contents are present in the head of the ampoule, for example based on an average RGB colour of the head of the ampoule. As ampoules may be stored upside down (i.e. with the ampoule head below its body), if the contents of an ampoule thaw in storage (due to e.g. a loss of power to the storage refrigeration device), a portion of the content will flow into the head of the ampoule. If the contents later refreeze (due to e.g. the power to the storage refrigeration device being restored), the contents will freeze in the head of the ampoule. Due to the shape of a typical ampoule (such as the neck constriction as shown in FIG. 1), the frozen contents will remain in the head of the frozen ampoule even when the ampoule is rotated, such as when it is removed from storage. As such, the presence of a frozen vaccine in an ampoule head provides an indication that a previous thawing has occurred. The colour of the ampoule head may be compared to a predetermined colour or range of colours, in a similar or same process to those described above.

It will be understood that the predetermined colour or range of colours used for each comparison process may be the same, or they may be different. For example, a first range of colours may be used to determine whether the ampoule is currently frozen, a second range of colours may be used to determine whether the ampoule has previously thawed, and a third range of colours may be used to detect a position of the ampoules in the ampoule holder 508.

The ampoule holder 508 may travel across the field of view of the photosensor 502 so that all ampoules in the ampoule holder are scanned by the photosensor 502. If any ampoules are found to contain thawed or thawed and refrozen contents, the system 500 may provide an error signal, for example to the machine controller, and/or halt the current operations of the machine.

The above described processes for detecting a position of any ampoules in the ampoule holder 508, whether the contents of any of the ampoules have thawed, and/or whether the contents of any of the ampoules have previously thawed and been refrozen may all occur concurrently during a single pass of the ampoule holder 508 across the field of view of the photosensor 502. Alternatively, the processes may occur in a sequence. For example, the ampoule holder 508 may travel through the field of view of the photosensor 502 multiple times, with an initial pass used to detect the position of the ampoules in the holder 508, and later passes used to detect whether the contents of any ampoules have thawed. In this case, the later one or more passes may be targeted on the slots of the ampoule holder in which the ampoules are known to be present based on the results of the first pass, for example by halting the ampoule holder 508 for a period of time when each of the ampoules present in the ampoule holder 508 enters the field of view of the photosensor 502.

The accuracy of the system 500 may be improved by providing a suitably coloured background 504. Ambient colours such as a colour of a background 504 will affect the average colour of light reflected by an ampoule and/or by any frost present on a frozen ampoule. In one example, blue (corresponding to photons with a wavelength of approx. 465-485 nm) and/or royal blue (corresponding to photons with a wavelength of approx. 450-465 nm) have been found to be advantageous background colours for use in determining whether some animal vaccines are frozen or have thawed. However, it will be understood that the most suitable background colour may vary depending on the colour of the ampoule itself and/or the colour of the contents of the ampoule.

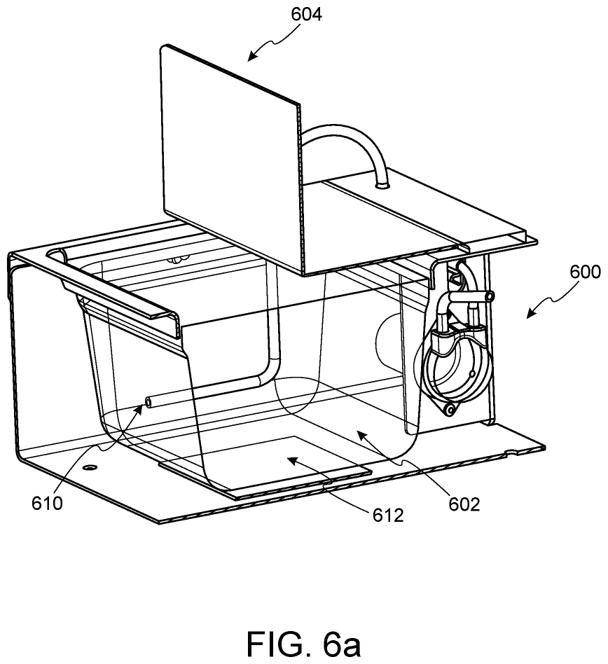

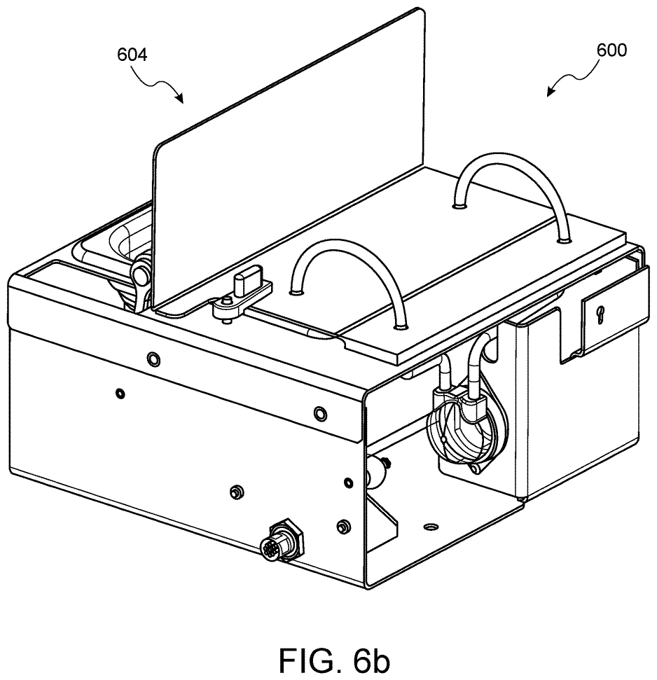

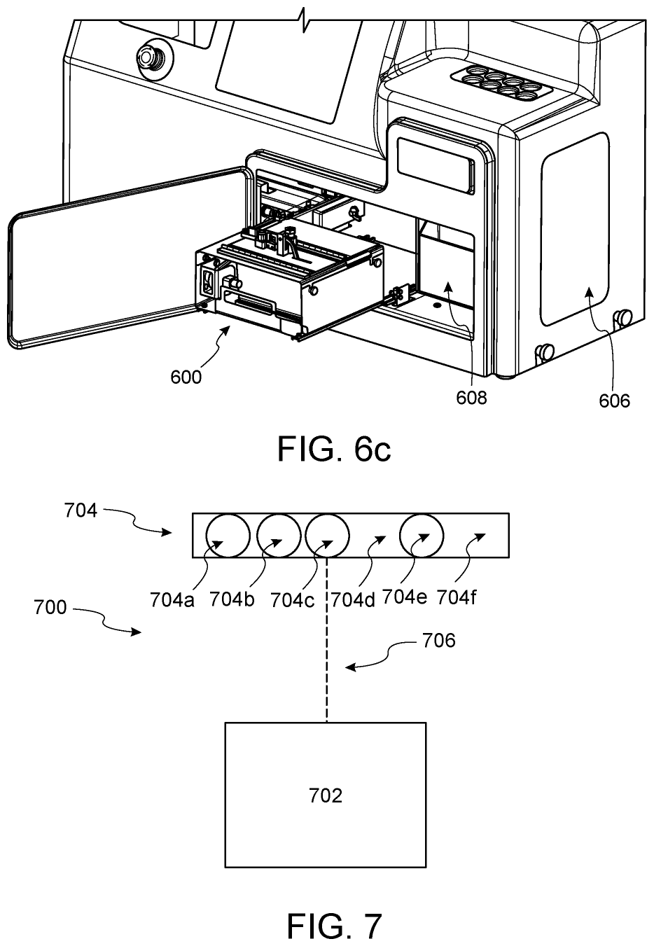

FIGS. 6a-c show an example water bath 600. The water bath 600 may be removable from the housing 606 of the machine via an aperture 608, for ease of cleaning and/or maintenance, as shown in FIG. 6c. It will be appreciated that aperture 608 is shown as an example, and the water bath 600 may additionally or alternatively be accessible or removable from the housing via one or more other apertures previously shown, such as apertures 206a or b shown in FIGS. 2a-c.

The water bath 600 comprises a container 602 that contains water or other liquids. The water bath is configured to receive the ampoule holder and thaw the ampoules. To this end, the water bath 600 comprises a temperature control system 612 and a water circulating system 610. The temperature control system 612 is used to maintain the temperature of the water at a desired level, and comprises one or more heaters, a thermal probe and a controller, such as a stepwise controller or a PID controller. The heaters may be operated using a step wise method, in which the heaters are either off or on at a set output level. However, it will be understood that the heaters may also have a variable output, to provide a greater degree of control over the heating of the water.

In some examples, the water in the water bath 600 may be maintained at a temperature of between 25 and 27 degrees Celsius, and the ampoules may be immersed in the water for up to or approximately 90 seconds. However, it will be understood that the optimal temperature of the water bath and the length of time for which the ampoules should be immersed may depend on the number and/or type of ampoules and their contents. As such, this information may be provided manually by the user via a user interface of the machine, or may be determined by the controller of the machine using a predetermined look up table, for example based on a number and/or position of ampoules in the ampoule holder as provided by the user or as detected in an earlier process. Maintaining the water of the water bath 600 at a set temperature via active heating assists in protecting the ampoules against overheating of their contents, and reduces the level of uncertainty over the length of time required to fully thaw the contents of the ampoules.

In addition to maintaining more uniform temperatures throughout the water bath, the movement of the water resulting from the water circulating system 610 assists in overcoming a boundary layer that may surround the ampoules (due to e.g. the surface tension between the water and the ampoules). The water circulating system 610 may therefore facilitate a more consistent heating of the ampoules and their contents.

The water bath 600 may be connected to a water source to provide an inflow of water to account for any water lost from the water bath 600 via e.g. evaporation or that remains on the ampoules or ampoule holder. The water level in the water bath 600 may be controlled by any suitable means, such as a float switch or an ultrasonic non-contact sensor. Sensors that avoid contact with the water, such as ultrasonic non-contact sensors, may be preferred in some implementations due to the inherently more hygienic nature of these sensors over contact based sensors. Detecting the water level facilitates the maintenance of the water level of the water bath 600 at a desired level, to e.g. avoid overfilling the container 602 (which may lead to spillages) or under filling the container 602 (which may result in the ampoules not being fully immersed in water and/or the heaters fully or partially contacting air instead of water).

The water bath 600 further comprises a lid or cover 604 to further reduce the risk of any spillage of water. The cover 604 may be controlled via electronic or mechanical means. For example, the cover 604 may be opened by contacting the ampoule holder as it is lowered towards and into the water bath 600. In some implementations, the water circulator 610 may be configured to only circulate water when the cover is open, to e.g. reduce energy consumption when the water bath 600 is not in use.

To avoid or reduce drippage, the ampoule holder may remain stationary over the water bath 600 for a period of time after being removed from the water, to allow the ampoules and ampoule holder to dry. The machine may comprise one or more brushes to wipe water from the ampoules and/or the ampoule holder, to reduce the time taken for this process and/or to remove excess water from the ampoules and/or ampoule holder. Additionally or alternatively, the ampoule holder may provide pneumatic motive forces or otherwise oscillate e.g. up and down or side to side, to assist with the removal of water from the ampoules and/or the holder itself.

FIG. 7 shows a schematic diagram of an example thaw detection system 700, comprising an Infra-Red (IR) thermometer, also called an IR scanner or IR sensor.

After exiting the water bath and/or drying, the ampoules may be scanned by an IR thermometer or scanner, such as non-contact IR scanner 702, to determine that the contents of the ampoules have been thawed by the water bath. If the ampoule contents have not thawed, the ampoule holder 704 may be configured or controlled to re-enter the water bath in a re-thaw loop, e.g. for a pre-determined amount of time. This process scanning the ampoules using the IR scanner 702 and entering a re-thaw loop may be repeated as many times as necessary to thaw the contents of the ampoules.

While a water circulating system in the water bath may circulate the water to reduce the possibility that only some (but not all) of the ampoules will thaw in a single cycle, in the event that this does occur, the controlled temperature of the water bath means that the thawed ampoules may be re-immersed in the water bath without risk of damage to the ampoule contents, e.g. from overheating. As a result, the machine may enter a re-thaw loop if the contents of any one or more of the ampoules in the ampoule holder 704 have not thawed in a given cycle.

The thaw detection system 700 may receive an indication of which slots 704a-f of the ampoule holder 704 contain ampoules (e.g. 704a, b, c and e). This indication may be provided via e.g. user inputs, or from an earlier ampoule detection process such as that described with regards to FIG. 5 above. Based on this indication, the IR scanner 702 may be configured to detect IR radiation from only those slots of the ampoule holder 704 that contain an ampoule.

Based on the detected IR radiation, the IR sensor 702 may be configured to determine a temperature of each of the ampoules, to thereby determine whether each of the ampoules (and their contents) have thawed. As such, IR sensor 702 or more generally the thaw detection system 700 may comprise a processor or be configured to provide data to an external computing system to process the detected data and thereby determine a temperature of each of the ampoules in the ampoule holder 704. From this information, the thaw detection system 700 or external computing device (such as the machine controller) may determine that all of the ampoules have thawed, or otherwise control or cause the ampoule holder to enter a re-thaw loop as discussed above.

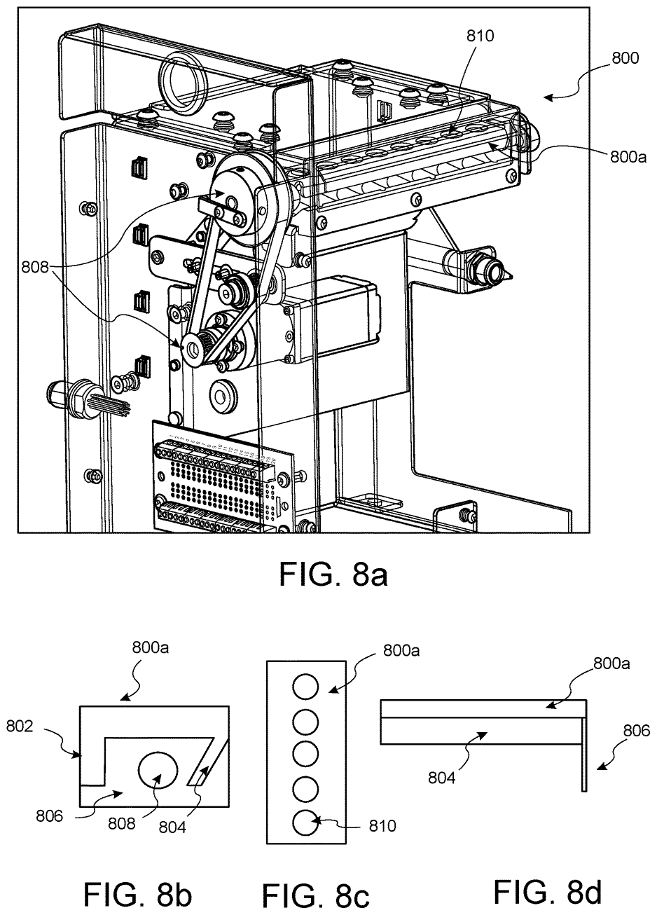

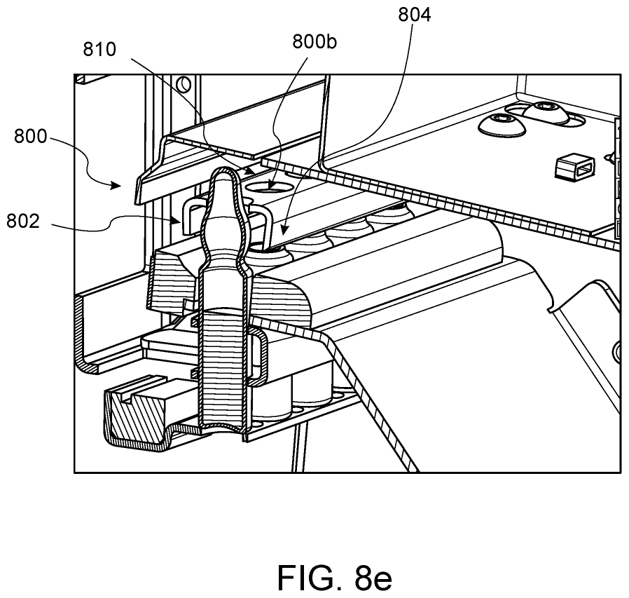

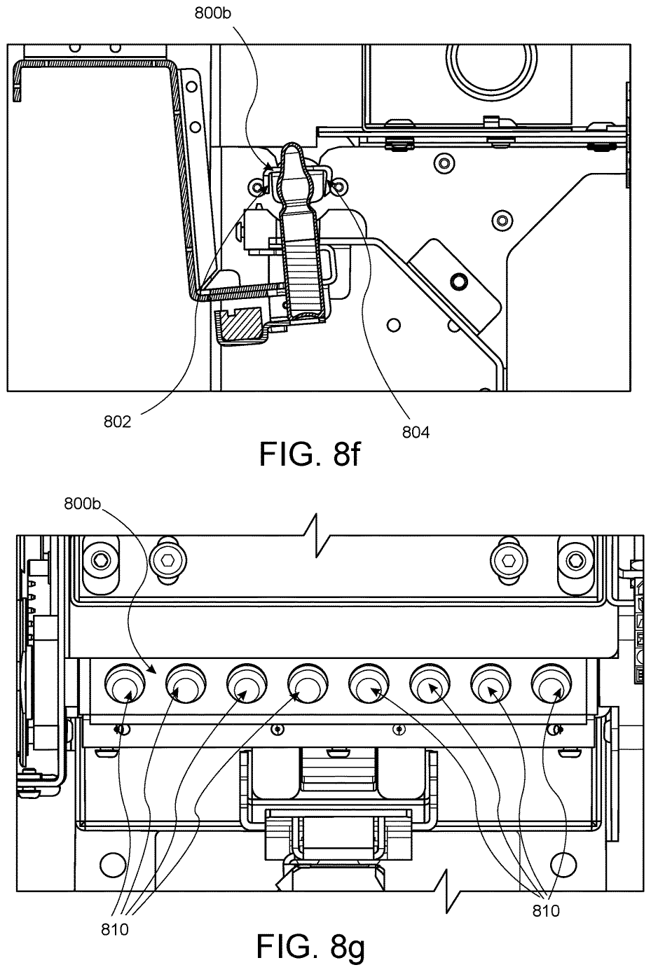

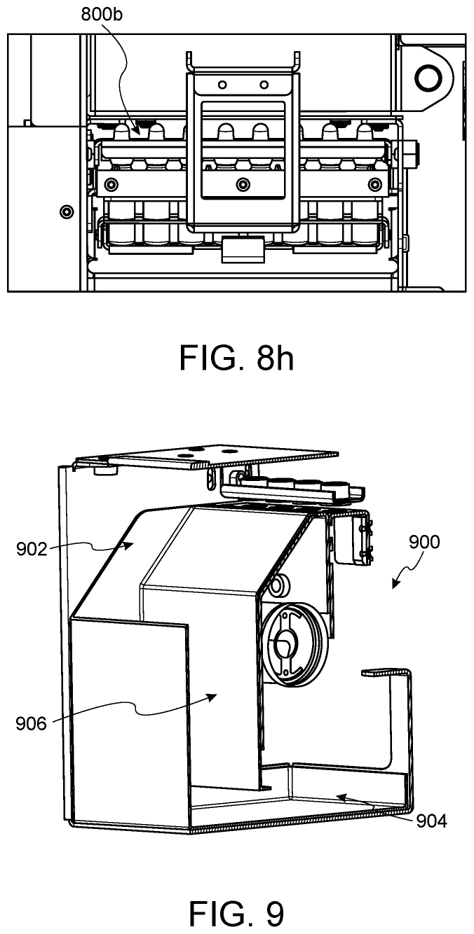

After the contents of the ampoules have been thawed, the ampoules are opened to enable the removal of their contents. To facilitate this, the machine comprises an ampoule opening assembly 800 to snap or crack the necks of the ampoules, and thereby remove the ampoule heads from the bodies, as shown in FIGS. 8a-h.

The ampoule opening assembly 800 comprises a fixed, rigid beam 800a with one or more openings or holes 810. The ampoule opening assembly 800 may have a number of holes equal to the maximum capacity of the ampoule holder, and the holes may be spaced such that the ampoules on the ampoule holder can each be simultaneously aligned with a hole 810 of the ampoule opening assembly 800. The ampoule opening assembly further comprises a back plate 806 for connecting the assembly 800 to a motor 808 or other rotation means, and flanges 802 and 804, as shown in FIGS. 8b-d.

In use, the beam 800a receives ampoules held by the ampoule carrier in its openings 810. After this, the motor 808 rotates the beam such that flanges 802 and 804 are brought into contact with a head and a neck of the ampoule respectively. The angle of flange 804 relative to the surface of the beam facilitates the simultaneous snapping of the necks of both small and tall ampoules, even with the size differences of the small and tall ampoules. As a result, the ampoule carrier may insert the ampoules into the beam by moving to a single fixed position, without the need to account for any size differences between the ampoules in the holder or for the user to otherwise insert only a single size (e.g. small or tall) of ampoule into the holder at any one time.

Upon the snapping of the ampoule necks, most ampoules heads will be ejected from the ampoule bodies by the force of the break. However, some ampoule heads may remain within the openings 810 of the beam 800a. As a result, after opening the ampoules, the ampoule carrier may be lowered and the beam may complete a full rotation to return to its starting position and deposit the remaining ampoules heads in a collection area, such as collection area 900 shown in FIG. 9.

FIGS. 8e-h depict an alternative implementation of the ampoule opening assembly 800b, with ampoules inserted into the openings 810. The features of the ampoule opening assembly 800b generally correspond to those of ampoule opening assembly 800, and like reference numerals are used for these features. In particular, ampoule opening assembly 800b comprises a first flange 802 protruding generally perpendicularly from the beam, and a second flange 804 that protrudes at a non-perpendicular (i.e. not 90 degree) angle to the beam. In both implementations, each flange may be between about 4 mm and about 12 mm in length, and the project at an angle from the beam of between about 70 degrees and about 110 degrees. It will also be understood that first flange 802 may also project from the beam at a non-perpendicular angle.

FIG. 9 shows a collection area 900 comprising an upper region 902 for receiving any ampoules heads ejecting during the snapping process, as well as a lower area 904 for receiving any ampoule heads that remain in the beam openings 810. The upper and lower areas may be connected via a chute 906, such that all ampoule heads are collected in the lower area 904. The lower area 904 may also be used for disposing of the ampoule bodies by the ampoule carrier, after the contents of the ampoules have been removed. For example, after the contents of the ampoules have been extracted, the ampoule carrier may be positioned above the lower area 904 and open its base, to discard the (empty) ampoule bodies.

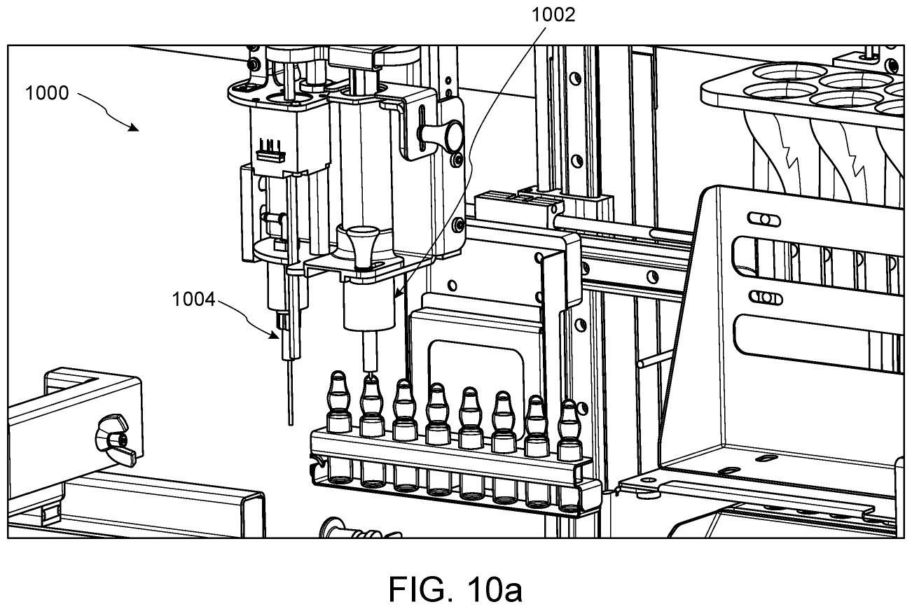

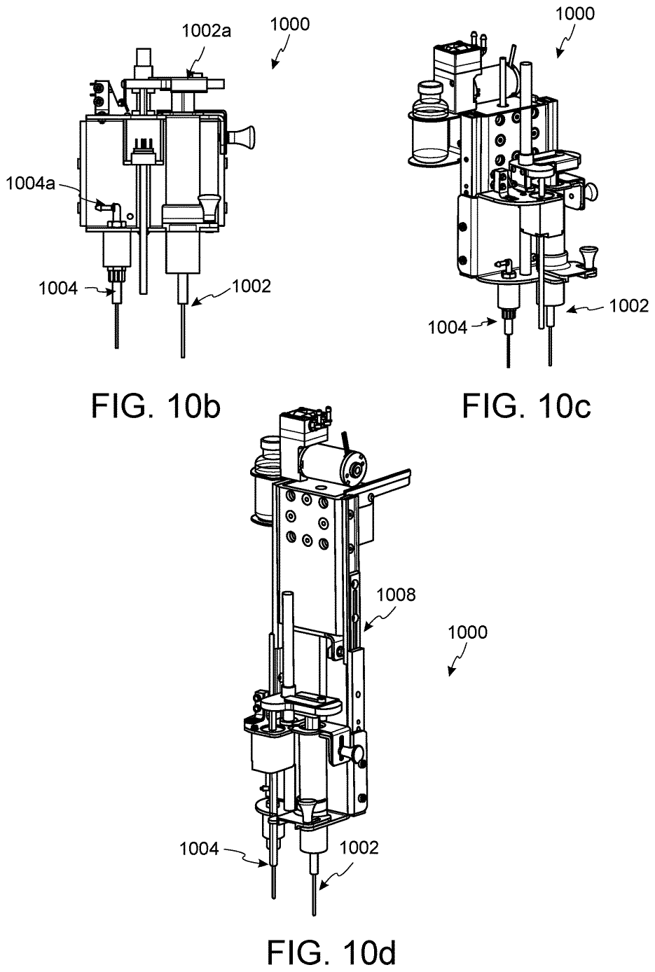

FIGS. 10a-d depict various views of an example syringe assembly 1000. The syringe assembly comprises a first syringe 1002 for extracting a vaccine from an opened ampoule and injecting the extracted vaccine into the diluent bag, and a second syringe 1004 for injecting a dye into a diluent bag. Each of the syringes 1002 and 1004 comprise an independent injection system 1002a, 1004a, for controlling the insertion and ejection of liquids from the syringes. Dyes are sometimes used in animal vaccines to assist in identifying which diluent bags contain a vaccine.

The syringe assembly 1000 may be mounted on a rail 1006 to allow the assembly to be aligned with any diluent bags and ampoules. In addition to movement along rail 1006, syringe assembly 1000 is movable perpendicularly to rail 1006 via arms 1008 between a fully extended position and a fully retracted position. The syringe assembly 1000 in a retracted position is shown in FIG. 10c, while the syringe assembly 1000 in an extended position is shown in FIG. 10d. It will be understood that the syringe assembly may be controlled to extend or retract to any position between the fully extended and retracted positions. For example, the syringe assembly may extend to a point half way between these two positions.

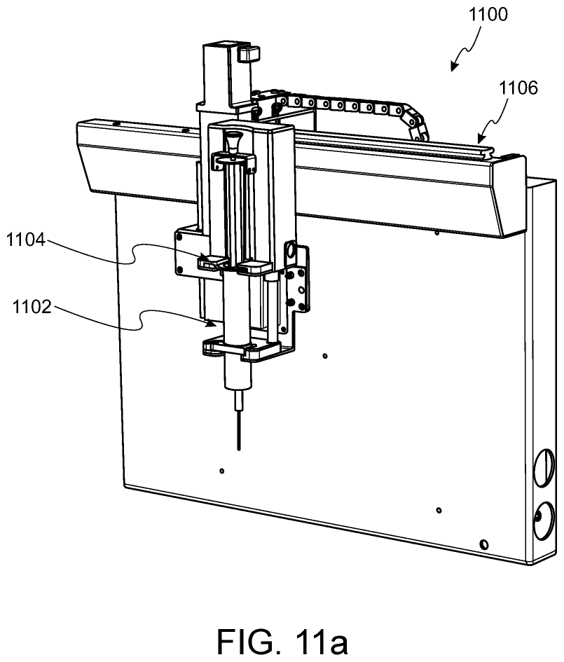

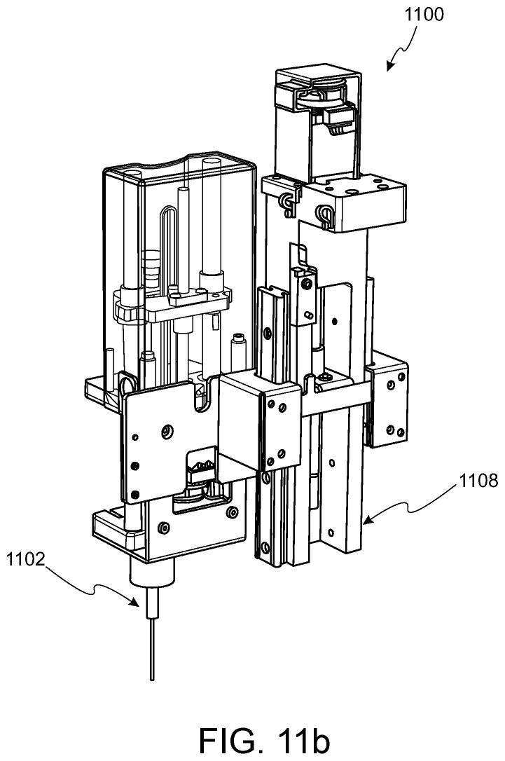

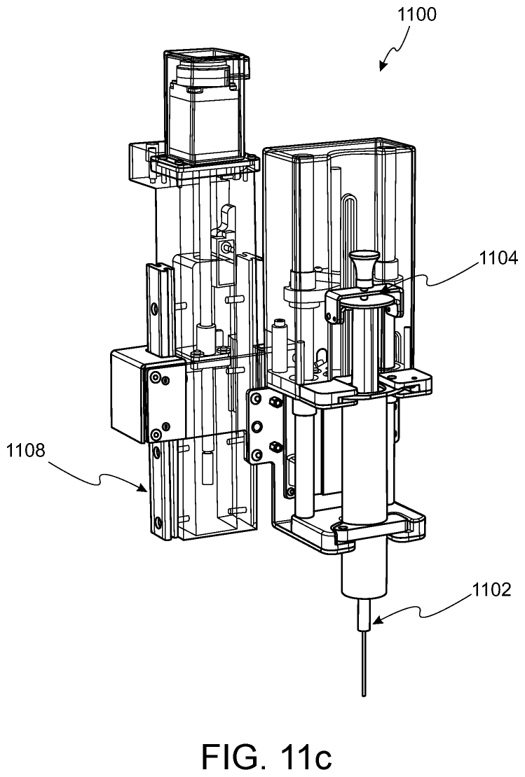

FIGS. 11a-c depict an alternative syringe assembly 1100 comprising a single syringe 1102 which may be controlled by injection system 1104 to inject both a dye and a vaccine into a diluent bag, as well as to extract the vaccine from the ampoules. s.

In use, syringe assemblies 1000, 1100 may optionally be configured to initially inject a dye into one or more diluent bags using syringes 1004 and 1102 respectively. After opening the one or more ampoules, the syringe assemblies 1000, 1100 may move along the rail 1100 to align with the one or more ampoules. The ampoules may be positioned in a known location, to facilitate this alignment. For example, after the ampoules have been opened by the ampoule opening assembly, the ampoule carrier may move to a set location to begin the vaccine extraction process. If multiple ampoules are present in the ampoule carrier, the syringe may be configured to extract a vaccine from each ampoule in the ampoule carrier. The user may input the number and/or location of the ampoules in the ampoule carrier, and/or the number/location of the ampoules may be detected by the system itself (for example, by the photosensor of the colour scanner system as described above) in an earlier process step.

Before or after aligning the syringe 1002, 1102 with the first ampoule, the injection system 1002a, 1104 may partially retract the plunger to create a small air bubble within the syringe 1002, 1102. The provision of this air bubble within the syringes may allow all of the vaccine removed from the ampoules to be later injected into the diluent bags.

The syringe assemblies 1000, 1100 then extends to insert the syringe 1002, 1102 into the first ampoule, and the injection assembly 1002a, 1104 retracts the plunger to remove the vaccine from the first ampoule. After this, the syringe assembly 1000, 1100 retracts and moves along the rail 1006 to align the syringes 1002, 1102 with the second ampoule, if present, and repeats the extraction process. This process may be repeated until the vaccine has been extracted from all of the ampoules placed in the ampoule carrier, or until the syringe 1002, 1102 is full. After this, the syringe assembly 1000, 1100 may move along rail 1006, and inject the vaccine into any diluent bags. The quantity of vaccine injected into the diluent bags is determined based on a travel or stroke length of the injection system 1002a, 1104 and the bore length of the syringe 1002, 1102. The amount of vaccine to inject into a given size of diluent bag may be determined using e.g. a predetermined list or matrix stored in a memory of the system controller. Similarly, as a known amount of vaccine is stored in each ampoule, the injection assembly can be controlled to retract the plunger by a suitable amount in order to remove all or most of the vaccine from the ampoule.

To facilitate the removal of the vaccine, the ampoule carrier (and therefore the ampoules in the ampoule carrier) may be rotated relative to the syringe assembly, for example by 5 degrees. This rotation results in the vaccine gathering in one side of the ampoule, allowing more of the vaccine to be extracted. The ampoule carrier may rotate after arriving at the vaccine extraction location, or it may be fixed at this rotation.

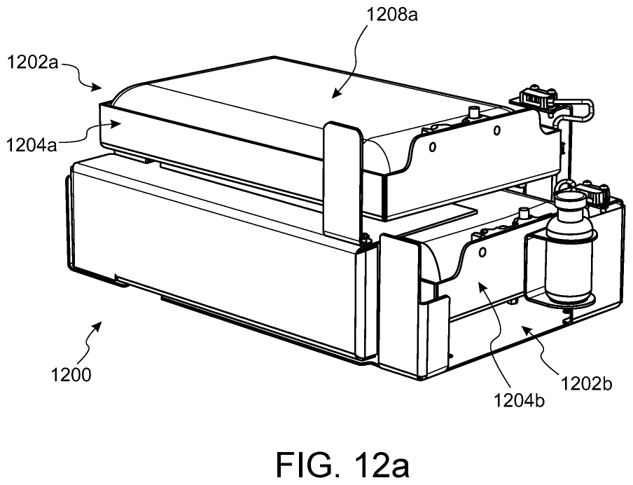

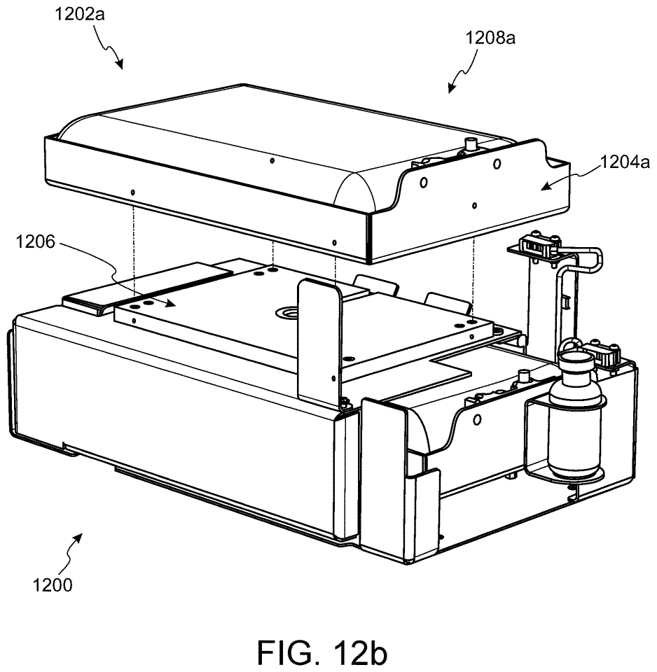

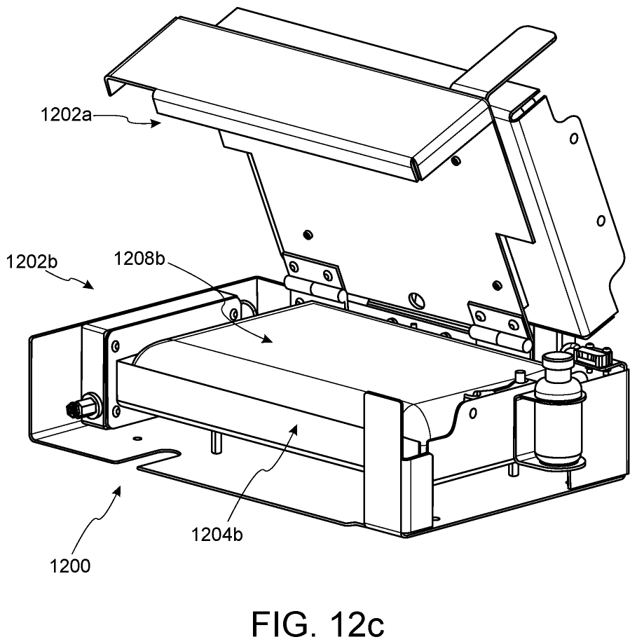

To further aid in this process, the syringes 1002, 1102 of the syringe assembly 1000, 1102 may be calibrated to determine an offset of their position from an expected position, as will be described in further detail with reference to FIG. 12 below.

While syringe assemblies 1000, 1100 have been depicted with a single syringe 1102 and/or a single pair of syringes 1002/1004, it will be understood that any number of syringes may be utilised. For example, the assemblies may comprise a single syringe/pair of syringes for each diluent bag that may be inserted into the machine (i.e. up to a maximum capacity of the machine) or may comprise a single syringe/pair of syringes for each ampoule that may be inserted into the ampoule carrier (e.g. up to a maximum ampoule carrying capacity of the ampoule carrier). Alternatively, assembly 1000 may comprise different numbers of the first and second syringes 1002, 1004. For example, the syringe assembly 1000 may comprise one second syringe 1004 for each diluent bag that may be inserted into the machine, and one first syringe 1002 for each ampoule that may be inserted into the ampoule carrier.

Additionally, each syringe in the syringe assembly 1000, 1100 may be replaceable, and may be e.g. a single use syringe.

FIGS. 12a-c depict various views of an example diluent bag holding system 1200. The system may comprise multiple diluent bag trays arranged next to or on top of each other. The system depicted in FIGS. 12a-c comprises a first tray 1202a positioned above a second tray 1202b. The upper tray(s) may be hinged, as shown in FIG. 12c, or otherwise removable to provide access to the lower tray(s). This stacked positioning of the multiple trays helps to maintain a smaller device size, for ease of storage. However, it will be appreciated that alternative arrangements (such as side by side arrangements) may be provided within the scope of the present disclosure.

Each tray 1202 comprises a diluent bag holder 1204a, b placed above a respective load cell 1206 or other measuring means. Diluent bags are available in multiple standardised sizes. As a result, the measurement of the load cell 1206 can be used to determine which size diluent bag 1208a, b has been placed in each holder 1204a, b. In addition, as the size of each diluent bag is known from this measurement, the load cell 1206 may further be used to determine a true height or length of a syringe.

While syringes are generally provided in standardised sizes, manufacturing tolerances may result in some discrepancy in terms of e.g. the needle length. As a result, it can be useful to determine an actual length of the syringe, for example in terms of an offset from an expected syringe length.

To achieve this, the syringe assembly may extend to lower the syringe until it contacts a diluent bag placed on one of the diluent bag holders 1204a, b. This contact will result in a change to the measurement of the load cell 1206, allowing the contact point for the syringe (and therefore its offset from an expected contact point) to be determined. This offset value may then be utilised during e.g. the vaccine extraction process, to ensure that the syringe is appropriately positioned in the ampoules for extracting the ampoule contents.

This calibration process may occur as an independent process, or may be combined with one or more other processes. For example, the syringe assembly may be calibrated during the injection of a dye into the diluent bags.

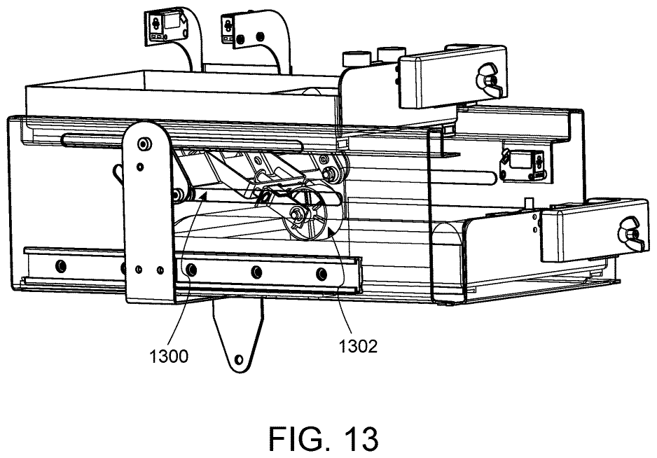

FIG. 13 depicts an example roller assembly 1300. As shown in FIG. 13, the roller assembly may roll across a diluent bag e.g. after or during the vaccine injection process, to mix the contents of the diluent bag. The movement of the diluent bag during extraction from the machine, in some applications, provides a sufficient mixing of the diluent bag contents. As such, the roller assembly 1300 is an optional feature of the machine.

The roller assembly 1300 comprises a wheel 1302 positioned above a diluent bag tray, configured to move along a rail system to thereby roll along the diluent bag. Optionally, a second lower wheel (not shown) may be positioned below the diluent bag, and provide further mixing to the diluent bag via a recess in the diluent bag holder. The movement of the upper and lower wheels may be synchronous, to improve the stability of the diluent bag, and the rollers may be configured to contact opposing sides of the diluent bag. One or both of the rollers may comprise spring loaded wheels, to provide consistent levels of pressure to the diluent bag during the mixing process.

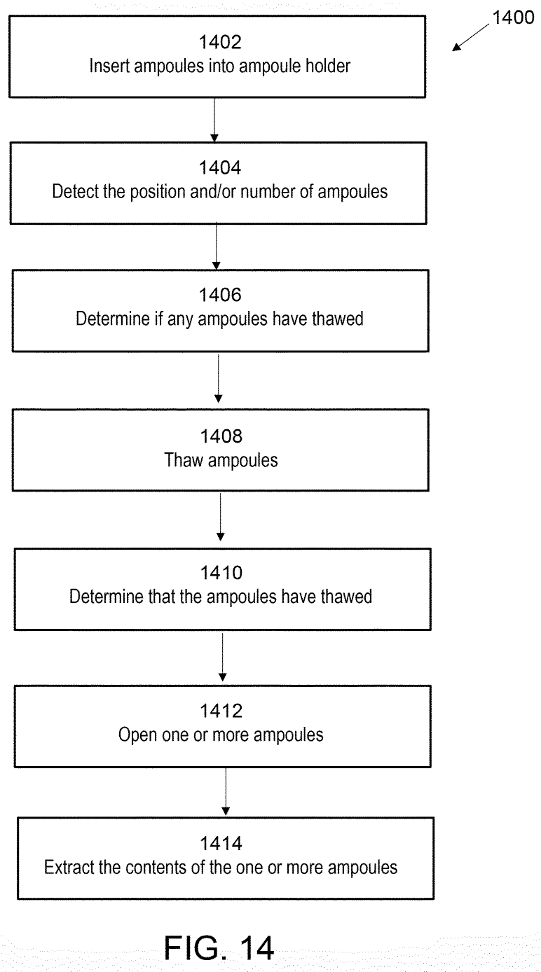

FIG. 14 depicts an example method 1400 for opening one or more ampoules and extracting the contents contained therein using a machine according to the present disclosure. It will be appreciated that the above described processes and steps may be implemented as parts of or in addition to each of these method steps, and/or that each method step may be performed as part of an isolated process.

In step 1402, one or more ampoules are inserted into an ampoule holder or carrier, for example via an ampoule receiver.

In step 1404, the position and/or number of ampoules in the ampoule carrier may be detected. Alternatively, the user may provide an indication of the number and/or position of the ampoules in the ampoule holder.

Step 1406 comprises determining whether any of the ampoules are thawed or have previously thawed. If any of the ampoules are determined to be thawed or have previously thawed, the method may comprise halting the method, or otherwise providing a warning or error signal to a user. Steps 1404 and 1406 may be performed by e.g. a colour scanner system.

In step 1408, the method comprises thawing the ampoules in the ampoule carrier. For example, the ampoules may be inserted into a water bath.

In step 1410, the machine may confirm that the ampoules in the ampoule carrier have all been thawed, for example via an IR thermometer or sensor. If any of the ampoules remain frozen or otherwise have not fully thawed, steps 1408 and 1410 may be repeated.

In step 1412, the ampoules are opened, for example by breaking the necks of the ampoules to remove the ampoule head from the ampoule bodies via an ampoule opening assembly.

In step 1414, a syringe is used to extract the contents of the (opened) ampoules in the ampoule carrier. Prior to or as part of this process, the heights or lengths of the syringes may be determined or calibrated.

After extracting the contents (e.g. vaccines) from the ampoules, the contents may be injected by the syringes into one or more diluent bags for use, or otherwise be retained in the syringes for direct injection into a patient.

Arrangements are defined by clauses E1 to E35 below:

E1. A method of calibrating a syringe assembly for removing a liquid from one or more ampoules, the method comprising:
exerting a force on a load cell with a syringe of the syringe assembly;
determining when the syringe assembly is exerting the force on the load cell based on an output of the load cell; and
determining a height of the syringe based on a position of the syringe assembly when the syringe contacts exerts the force on the load cell.

E2. The method of clause E1, further comprising providing a body of a known size on the load cell, and wherein the step of exerting a force on a load cell with a syringe of the syringe assembly comprises bringing the syringe into contact with the body; and
optionally wherein the body is a diluent bag and providing the body comprises:
   depositing the diluent bag on the load cell; and
   determining a size of the diluent bad based on a measurement of the load cell.

E3. The method of clause E1 or E2, wherein determining the height of the syringe comprises determining an offset value from a theoretical syringe height.

E4. A method of removing a liquid from one or more ampoules, the method comprising:
calibrating a syringe assembly comprising one or more syringes according to any one of clauses E1-E3;
aligning the syringe assembly with an ampoule;
inserting the syringe into the ampoule using the determined height of the syringe such that a tip of the syringe is adjacent to but not touching a base of the ampoule; and
removing the liquid from the ampoule using the syringe.

E5. The method of clause E4, comprising placing the ampoule in a fixed position, optionally wherein in the fixed position an axis of the ampoule is at an angle of up to 10 degrees from the direction of a needle of the syringe, and preferably wherein the angle is 5 degrees.

E6. The method of clause E4 or E5, further comprising detecting a position of the one or more ampoules; and
aligning the syringe assembly with an ampoule based on the detected position of the ampoule.

E7. The method of any one of clauses E4 to E6, further comprising, prior to inserting the syringe into a first ampoule of the one or more ampoules, drawing air into the syringe to form an air bubble in the syringe.

E8. The method of any one of clauses E4 to E7, wherein the one or more ampoules comprises a plurality of ampoules, and wherein:
aligning the syringe assembly with an ampoule comprises aligning the syringe assembly with a first ampoule of the plurality of ampoules;
inserting the syringe into the ampoule comprises inserting the syringe into the first ampoule using the determined height of the syringe such that a tip of the syringe is adjacent to but not touching a base of the first ampoule; and
removing the liquid from the ampoule comprises removing the liquid from the first ampoule using the syringe;
and wherein the method comprises, after removing the liquid from the first ampoule:
aligning the syringe assembly with a second ampoule of the plurality of ampoules;
inserting the syringe into the second ampoule using the determined height of the syringe such that a tip of the syringe is adjacent to but not touching a base of the second ampoule; and
removing the liquid from the second ampoule using the syringe.

E9. A calibration system for implementing the method of any one of clauses E1 to E3, the system comprising:
a syringe assembly comprising one or more syringes, and
a load cell, wherein the syringe assembly is movable relative to load cell

E10. A system for implementing the method of any one of clauses E4 to E9, the system comprising:
the calibration system of clause E9; and
an ampoule holder configured to hold one or more ampoules.

E11. A method of detecting whether contents of an ampoule have thawed, the method comprising:
detecting, by a photosensor, an average colour of an ampoule;
compare the detected colour of the ampoule to a predetermined colour; and
determine, based on the comparison, whether the contents of the ampoule have thawed.

E12. The method of clause E11, wherein the method comprises providing a background with an average colour corresponding to photons with a wavelength between 450-485 nanometres, and preferably wherein the background has an average colour corresponding to photons with a wavelength between 450-465 nanometres.

E13. The method of clause E11 or E12, comprising detecting, by the photosensor, a position of the ampoule.

E14. The method of any one of clauses E11 to E13, wherein the step of comparing the detected colour of the ampoule to a predetermined colour comprises comparing the detected colour to a selection of predetermined colours in a look up table.

E15. The method of any one of clauses E11 to E14, wherein the step of comparing the detected colour of the ampoule to a predetermined colour comprises determining a photon wavelength that corresponds to the detected colour, and comparing the determined photon wavelength to a range of photon wavelengths.

E16. A system for implementing the method of any one of clauses E11 to E15, the system comprising a photosensor.

E17. The system of clause E16, comprising a background positioned in a field of view of the photosensor, wherein the background has an average colour corresponding to photons with a wavelength between 450-485 nanometres.

E18. A system for extracting a liquid from an ampoule, the system comprising:
an ampoule carrier for holding one or more ampoules,
a photosensor configured to detect an average colour of each of the one or more ampoules;
a beam comprising at least one opening for receiving part of an ampoule, wherein the system is configured to rotate the beam relative to the ampoule carrier, the rotation to cause opposite the beam to apply pressure to a said received ampoule held by the ampoule carrier, to thereby break off a said part of the ampoule received by the opening;
a load cell;
a syringe assembly comprising one or more syringes, wherein the syringe assembly is movable relative to the load cell and configured to remove a liquid from the one or more ampoules; and
one or more processors configured to:
   compare the detected colour of the ampoule to a predetermined colour;
   determine, based on the comparison, whether contents of the ampoule have thawed, wherein the system is configured to halt or delay a process for progressing the opening of or processing the contents of at least the one or more ampoules that are determined to have thawed;
   detect when the syringe assembly is in contact with the load cell or a body disposed on the load cell based on an output of the load cell; and
   determine a height of the one or more syringes based on a position of the syringe assembly when the syringe assembly is in contact with the load cell or the body; and.
      wherein the syringe assembly is configured to remove a liquid from the one or more ampoules based on the determined height of the one or more syringes.

E19. The system of clause E18, comprising a water bath configured to receive one or more ampoules held by the ampoule carrier and thaw contents of at least one of the ampoules.

E20. The system of clause E18 or E19, comprising an IR thermometer for detecting a temperature of one or more ampoules held by the ampoule carrier, wherein the IR thermometer is configured to determine whether contents of the one or more ampoules held by the ampoule carrier have thawed.

E21. The system of any one of clauses E18 to E20, comprising a syringe assembly, the syringe assembly comprising one or more syringes for removing liquid from one or more ampoules.

E22. The system of clause E21 configured to, during the removal of the liquid from one or more ampoules, rotate the carrier preferably by between about 5 degrees and about 10 degrees.

E23. The system of clause E21 or E22, comprising a diluent bag holder for holding one or more diluent bags, wherein the one or more syringes are configured to insert the removed liquid into one or more diluent bags held by the diluent bag holder.

E24. The system of clause E23, comprising rollers configured to mix the liquid in the diluent bags.

E25. The system of clause E24, wherein the rollers comprise a first roller and a second roller, and wherein the first and second rollers are configured to contact opposite sides of the one or more diluent bags.

E26. The system of clause E25, wherein the first and second rollers comprise spring loaded wheels.

E27. The system of any one of clauses E24 to E26, wherein the rollers are configured to contact one or more diluent bags held by the diluent bag holder during the insertion of the liquid by the one or more syringes into the one or more diluent bags.

E28. The system of any one of clauses E24 to E27, comprising a dye injector configured to inject a dye into the one or more diluent bags.

E29. The system of any one of clauses E18 to E28, wherein the carrier is configured to, after the removal of the liquid, deposit the one or more ampoules in a collection area.

E30. The system of any one of clauses E18 to E29, comprising a housing enclosing the ampoule carrier and the beam.

E31. The system of clause E30, wherein the ampoule carrier is movable relative to the housing.

E32. The system of any one of clauses E18 to E31, comprising an ampoule receiver for inserting the one or more ampoules into the ampoule carrier, wherein the ampoule receiver comprises a first opening for receiving an ampoule and a second opening for depositing the ampoule into the ampoule carrier, and wherein the first opening has a greater area than the second opening.

E33. The system of any one of clauses E18 to E32, comprising a controller configured to control movement of the ampoule carrier and/or beam relative to one another to perform the insertion of the one or more ampoules into the openings.

E34. A method of extracting a liquid from an ampoule, the method comprising:
depositing one or more ampoules into an ampoule carrier;
detecting, by a photosensor, an average colour of an ampoule;
comparing the detected colour of the ampoule to a predetermined colour;
determining, based on the comparison, whether the ampoule is thawed;
receiving the one or more ampoules into respective openings of a beam;
rotating the beam to relative to the ampoule carrier, the rotation to cause the beam to apply pressure to the one or more ampoules and thereby break off a said part of the ampoule received by the opening
exerting a force on a load cell with a syringe of the syringe assembly;
determining when the syringe assembly is exerting the force on the load cell based on an output of the load cell; and
determining a height of the syringe based on a position of the syringe assembly when the syringe contacts exerts the force on the load cell;
aligning the syringe of the syringe assembly with an opened ampoule;
inserting the syringe into an ampoule using the determined height of the syringe such that a tip of the syringe is adjacent to but not touching a base of the ampoule; and
removing the liquid from the ampoule using the syringe.

E35. A use of the system or method of any one of clauses E23 to E33 for preparing one or more diluent bags comprising a vaccine.

1. A system for opening ampoules, the system comprising:
a beam comprising at least one opening for receiving part of an ampoule; and
an ampoule carrier for holding one or more ampoules,
wherein the system is configured to rotate the beam relative to the carrier, the rotation to cause opposite sides of said opening to apply pressure to said received ampoule held by the carrier, to thereby break off said part of the ampoule received by the opening.

2. The system of claim 1, wherein the ampoule carrier and/or beam are configured to align one or more said ampoules held by the carrier with respective openings of a snapper.

3. The system of claim 1, comprising a bottom plate configured to support the ampoule carrier during the rotation of the beam.

4. The system of claim 1 configured to, after breaking off said part of the one or more ampoules, rotate the beam to deposit said part of the ampoule into a collection area.

5. The system of claim 1 comprising a photosensor, wherein the photosensor is configured to determine if contents of the one or more ampoules held by the ampoule carrier have thawed, and
wherein the system is configured to halt or delay a process for progressing the opening of or processing the contents of at least the one or more ampoules that are determined to have thawed.

6. The system of claim 1, comprising a water bath configured to receive one or more ampoules held by the ampoule carrier and thaw contents of at least one of the ampoules.

7. The system of claim 6, comprising an Infra-Red (IR) thermometer for detecting a temperature of one or more ampoules held by the ampoule carrier, wherein the IR thermometer is configured to determine whether the contents of one or more ampoules held by the ampoule carrier have thawed.

8. The system of claim 6, comprising a syringe assembly, the syringe assembly comprising one or more syringes for removing a liquid from one or more ampoules.

9. The system of claim 8 configured to, during the removal of the liquid from the one or more ampoules, rotate the carrier by between about 5 degrees to about 10 degrees.

10. The system of claim 8, comprising a diluent bag holder for holding one or more diluent bags, wherein the one or more syringes are configured to insert the removed liquid into one or more diluent bags held by the diluent bag holder.

11. The system of claim 10, comprising rollers configured to mix the liquid in the diluent bags.

12. The system of claim 11, wherein the rollers comprise a first roller and a second roller, and wherein the first and second rollers are configured to contact opposite sides of the one or more diluent bags.

13. The system of claim 12, wherein the first and second rollers comprise spring loaded wheels.

14. The system of claim 11, wherein the rollers are configured to contact one or more diluent bags held by the diluent bag holder during the insertion of the liquid by the one or more syringes into the one or more diluent bags.

15. The system of claim 10, comprising a dye injector configured to inject a dye into the one or more diluent bags.

16. The system of claim 8, wherein the carrier is configured to, after the removal of the liquid, deposit the one or more ampoules in a collection area.

17. (canceled)

18. The system of claim 1, wherein the ampoule carrier is movable relative to a housing.

19. The system of claim 1, comprising an ampoule receiver for inserting the one or more ampoules into the ampoule carrier, wherein the ampoule receiver comprises a first opening for receiving an ampoule and a second opening for depositing the ampoule into the ampoule carrier, and wherein the first opening has a greater area than the second opening.

20. The system of claim 1, comprising a controller configured to control movement of the ampoule carrier and/or beam relative to one another to perform the ampoule insertion.

21. (canceled)

22. A method for opening ampoules, comprising:
a beam comprising at least one opening for receiving part of an ampoule; and
an ampoule carrier for holding one or more ampoules,
wherein the method comprises the steps of:
rotating the beam relative to the carrier, the rotation to cause opposite sides of said opening to apply pressure to said received ampoule held by the carrier; and
breaking off said part of the ampoule received by the opening.
